(19) United States
(12) Patent Application Publication
(10) Pub. No.: US 2006/0065086 A1
(43) Pub. Date: Mar. 30, 2006

(54) Window covering cutting apparatus and methods

(75) Inventors: Cletis Frazier Swopes, Janesville, WI (US); Joyce Anne Rogowski, Waunakee, WI (US); Steven John Neumaier, Sauk City, WI (US); James Anthony Laubmeier, Cross Plains, WI (US); Kipley Tad Carpenter, Stoughton, WI (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Springs Window Fashions LP, Fort Mill, SC (US)

(21) Appl. No.: 11/105,117

(22) Filed: Apr. 13, 2005

Related U.S. Application Data
(60) Provisional application No. 60/561,650, filed on Apr. 13, 2004.
(60) Provisional application No. 60/561,621, filed on Apr. 13, 2004.

(51) Int. Cl. B26D 7/02

(52) U.S. Cl. 83/13; 83/197; 83/467.1

(57) ABSTRACT

A cutdown machine and method are disclosed. The cutdown apparatus preferably includes a pair of cutting assemblies for simultaneously cutting the ends of a window covering. Additionally, a calculation apparatus and method for use in conjunction with the cutdown machine are also disclosed. The calculation apparatus may be a stand alone unit, or preferably integrated into the cutdown machine. The calculation apparatus preferably calculates and automatically positions a stop element in the cutdown machine, in connection with desired end window covering dimensions and related stock window covering sizes.

### CROSS-REFERENCE TO RELATED APPLICATIONS

This application claims the benefit of the filing date of U.S. Provisional Patent Application No. 60/561,621 filed on Apr. 13, 2004 and U.S. Provisional Patent Application No. 60/561,650 filed Apr. 13, 2004, the disclosures of which are hereby incorporated herein by reference.

### BACKGROUND OF THE INVENTION

The present invention relates to cutting apparatus and methods for trimming window coverings such as window blinds that are trimmed at the time of purchase at retail stores.

Over the past several years, different approaches have evolved with regard to preparing window blinds and other window coverings such that they have the dimensions needed to cover a particular window (or other architectural opening) for a particular customer. One approach, which has long existed, involves the initial measuring of a window by an installer or decorator to determine the appropriate dimensions of the blind. This measuring step is followed by an order being placed with the manufacturer (or an authorized fabricator), where the blind is thereafter built to the particular specifications of the customer's window. The blind is then shipped and eventually installed. While the foregoing procedure normally provides satisfactory results in terms of the customer ultimately obtaining a blind that appropriately fits his or her window, there is an obvious disadvantage to this procedure, namely, the time associated with each of the foregoing steps, whereby it could take several days or even several weeks from beginning to end.

Another approach that has been employed involves manufacturing and supplying retail stores with blinds having a number of “stock” sizes. Each blind is provided in a variety of such “stock” sizes, such that the customer can select a blind size that most closely approximates the size of the window to be covered. The drawbacks to this approach have long been self-evident. If a small number of stock sizes are provided, the likelihood of a customer finding a stock size that appropriately fits the customer's window is necessarily reduced. While this problem can be mitigated by providing more and different stock sizes, this necessarily results in the need for retailers to take on greater inventory and provide more shelf space for the blinds in question. These problems are exacerbated by the fact that blinds are typically offered in different colors and styles, and if it is necessary to stock numerous sizes of each color and style, the inventory and shelf space problems will increase accordingly.

A solution to the foregoing problems has led to what is now a popular approach to selling blinds and other window coverings. Under this approach, sometimes referred to as the “size-in-store” system, a relatively small number of stock sizes of each blind are provided to the retail store. The blinds themselves are designed in a manner that the headrails, slats (or other window coverings) and bottom rails can be trimmed at either (or preferably both) ends. This is accomplished by such stock blinds having lifting, tilting and similar mechanisms, and cords positioned inwardly from the outer edges of the window coverings, such that the ends can be trimmed to the degree desired without impairing the operation of the window covering. Such “size-in-store” systems typically involve the retail store being provided with a cutdown machine designed to cut the particular blinds or other window coverings. Non-limiting examples of such cutdown machines are illustrated by U.S. Pat. Nos. 6,178,857 and 6,681,673, both of which are incorporated herein by reference in their entirety.

While many different types of cutdown machines exist, certain characteristics are common to many, if not most, of such machines. First, they will typically include means for cutting the headrail, the slats (or other window covering material) and the bottom rail of the window covering in question. In certain situations, such as illustrated in the aforementioned U.S. Pat. No. 6,178,857, different approaches and tools are used to cut the headrail, the slats and/or the bottom rail. Additionally, cutdown machines will typically allow for both sides of the window covering to be cut. Clearly, for a trimmed window covering to have an attractive finished look, the amount that is cut from each component must be the same to the extent possible, such that it is typically necessary to make certain that all components are lined up appropriately.

Various other machines and methods for performing these tasks are disclosed in U.S. Pat. Nos. 5,339,716; 5,037,253; 5,456,149; 4,993,131; 5,072,494 and 5,103,702, the disclosures of which are all hereby incorporated by reference herein. However, these various disclosures, in addition to the above, have been generally inadequate at providing systems for efficiently and accurately sizing window shades to specified lengths. For example, most of the systems disclosed are too complex to be operated by a typical retail salesperson having an average degree of training. In addition, many of these systems require numerous steps in order to cut the window shade, i.e. the head rail is cut in a first cutting operation and the window covering material is cut in a second cutting operation. Further, these systems, and particularly the cutting blades of these systems exert a tremendous amount of force upon the window shade being cut which often results in the cut ends of the shades being uneven, chipped or cracked. These defects produce a final product of inferior quality.

The foregoing problems and concerns are particularly pronounced in the environment of a retail store, such as a home improvement store. In those situations, the responsibility for trimming blinds will often rest on a sales associate who will typically be hired with no background or experience in trimming blinds. While training may be offered by the retail store or by the blind supplier, with regard to trimming blinds (as with any other endeavor) there is a learning curve. Moreover, it is common for retail stores to have turnover in staff, such that sales associates may be asked to trim blinds with little or no training or experience. When mistakes are made in trimming blinds, it is often necessary to discard a blind and start over, thus impacting on the profitability of the program. Retail stores are also consistently making staffing cutbacks and expecting associates from other departments of the store to cover the window blind department, when needed. For example, an associate who normally works in the plumbing department may be asked to assist a consumer with cutting a blind.

One specific area that often creates the most confusion with the operation of a cutdown machine is determining the amount of the blind to cut. Typically, an operator will set end stops located in the cutting machine to place the cutting instruments of the machine at the desired locations for cutting. In current methods, a sales associate obtains style, measurement and installation information from the consumer, and using a conversion wheel or chart, attempts to obtain the cutdown end stop values. Based on these entries, the store associate extracts a range of widths, which he or she must them compare against the available sizes of stock window blinds in the store. He or she will then make a decision on a starting blind size and thereafter determine from the wheel (being sure the wheel is lined up correctly) or chart the amount he or she needs to cut off that particular blind. The store associate must then read a ruler printed on the wheel (or take the resulting number from the chart) and manually set the end stop on the cutdown machine accordingly.

Typically, there are multiple product lines in a cutdown program and many different machines with which to cut them. Cutoff amounts vary by product line and type of window covering. End stops and cutting instructions vary by cutdown machine. Untrained, new, or mathematically challenged store associates often have difficulty with cut calculations and correctly setting the machines for the appropriate cut amounts. Thus, the above described methods are unable to significantly alleviate the human error factor. That is, all solutions currently available rely on store associates to make independent and initial decisions on starting blind size and to read and interpret sizing wheels, rulers and measurements. All known methods currently available require store associates to know how to read and comprehend various blind specifications and conversions and to understand and use a tape measure/ruler to set end stops and cut amounts.

Therefore, there is a need for a cutting apparatus for window shades capable of efficiently customizing window shades to fit window dimensions specified by customers. There is also a need for a cutting apparatus for cutting a window shade to a specified length, whereby the entire window shade, namely the head rail, the bottom rail and the window covering material are all cut simultaneously in a single cutting stroke, thereby saving time and reducing operator errors. Moreover, the cutting apparatus should produce a final product having a high quality and professionally cut appearance. In addition, there is also a need for a simplified cutdown process that requires less training, less manual calculating and less decision making on behalf of the store associate, and thus allows for less room for human error and the resulting build up of unusable blind assemblies.

### SUMMARY OF THE INVENTION

A first aspect of the present invention is an apparatus for cutting a window covering having first and second ends, a headrail, a bottom rail and window covering material extending therebetween. In accordance with one embodiment of this first aspect, the apparatus includes a user interface for receiving information relating to the window covering, a base supporting a stationary cutting assembly and a moveable cutting assembly, each cutting assembly including a die and a shear adapted to cut the headrail and a saw adapted to cut the window covering material and the bottom rail and a stop that is automatically positioned with respect to the stationary cutting assembly in response to the information received by the user interface. The stop preferably allows for the moveable cutting assembly to be properly positioned.

A second aspect of the present invention is a method of simultaneously cutting first and second ends of a window covering in a cutting machine. In accordance with one embodiment of this second aspect, the method includes the steps of entering information relating to the window covering into a user interface of the cutting machine, selecting an appropriately sized window covering, inserting a first end of the window covering into a die of a stationary cutting assembly of the cutting machine, inserting a second end of the window covering into a die of a moveable cutting assembly of the cutting machine and activating the cutting assemblies so as to simultaneously cut the first and second ends of the window covering.

A third aspect of the present invention is a method for calculating cutting dimensions for trimming a window covering. In accordance with one embodiment of this third aspect, the method includes the steps of providing the type of the window covering, providing measurements of the window covering, providing mounting information of the window covering, verifying the previously entered information, referring to a data matrix of acceptable and available window covering sizes based on the previously entered information, prompting a user to select a starting window covering size from a selected group, the selected group being a subset of the data matrix and calculating a stop value based upon the selected window covering size.

Yet another aspect of the present invention includes a user-interactive data entry and conversion apparatus for guiding a store associate through a step-by-step process for determining the proper measurements for cutting down a blind. Preferably, the apparatus will be capable of interfacing with an in-store cutdown machine like those described in the aforementioned patents. The apparatus will preferably include graphic depictions of mounting styles, tape measures and end stop settings. The apparatus will include various language choices such as Spanish, for its prompting messages and interactive instruction screens and will preferably allow entries in both English and Metric measurements. Alternatively, the apparatus can be remote from the cutdown apparatus, either in the store or a remote location.

In a preferred embodiment, the store associate will be prompted with a series of multiple choice questions regarding a consumer's desired purchase to determine what blind size to start with and how much to cut off the blind to achieve the desired size. Preferably, the store associate will be prompted to input the type of blind, the custom measurements and whether the blind will be an inside or outside mount.

Preferred embodiments of the present invention provide an automated process for receiving consumer custom window blind information and performing mathematic calculations in order to convert consumer custom size requests into end stop values. More preferably, the end stop value is depicted in a graphic representation showing the exact location on a ruler where the sales associate is to set the end stop.

Other preferred embodiments include additional features. For example, the methods and apparatus herein described eliminate the need for the store associate to understand the required measurement difference between inside and outside mounted blinds. Moreover, the methods and apparatus are capable of handling the option to re-cut a blind that was previously cut and advised to cut off one side or both based on the amount being cut.

Preferably, the apparatus provides for different user languages such as Spanish as an option. Furthermore, measurements are preferably entered in English but may also be entered in Metric units. The apparatus preferably uses Flash Media or other technology to download and transfer data.

There are certain advantages to the methods and apparatus described herein relating to aspects of the present invention. For example, the method and apparatus described herein eliminates the need for the store associate to understand cutoff amounts in relation to starting blind size by referencing customer-specific assortments and offering the store associate a list of starting blind sizes to choose from.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1A is a perspective front view of a window covering cut to a specified length.

FIG. 1B is a side view of the window covering shown in FIG. 1A.

FIG. 2 is a perspective view of a cutting apparatus for cutting a window covering to a desired length according to one embodiment of the present invention with the cover of the cutting apparatus in a closed position.

FIG. 3 is a perspective view of the cutting apparatus shown in FIG. 2 with the cover of the cutting apparatus in an open position and certain portions of the apparatus hidden to uncover certain components.

FIG. 4 is a partial perspective view of the cutting apparatus shown in FIG. 3, depicting a moveable cutting assembly portion.

FIG. 5 is a partial rear perspective view of a stationary cutting assembly portion of the cutting apparatus shown in FIG. 3.

FIG. 6 is a perspective view of a cutting assembly removed from the cutting apparatus.

FIG. 7 is a right side view of the cutting assembly shown in FIG. 6.

FIG. 8 is a right side view of the cutting assembly of the cutting apparatus shown in FIG. 7 with certain components hidden so as to show the actuation mechanism of the headrail cutting portion.

FIG. 9 is a partial right perspective view of the moveable cutting assembly of the cutting apparatus shown in FIG. 6 with certain components hidden so as to show the drive mechanism for the shear and saw mechanisms.

FIG. 10 is a partial left perspective view of the moveable cutting assembly of the cutting apparatus shown in FIG. 6 with certain component hidden so as to show the drive mechanism for the shear and saw mechanisms.

FIG. 11a is a right side view of an alternate embodiment cutting assembly with a headrail cutting portion in an initial position.

FIG. 11b is a right side view of the cutting assembly shown in FIG. 11a with the headrail cutting portion in a rotated position.

FIG. 12 is a perspective view of a cutting apparatus for cutting a window covering to a desired length according to an embodiment of the present invention which employs cutting assemblies shown in FIGS. 11a and 11b, with the cover of the cutting apparatus in a closed position.

FIG. 13 is a perspective view of the cutting apparatus shown in FIG. 12 with the cover of the cutting apparatus in an open position and certain portions of the apparatus hidden to uncover certain components.

FIG. 14 is a partial perspective view of the cutting apparatus shown in FIG. 13, depicting a moveable cutting assembly portion.

FIG. 15 is a perspective view of a clamp mechanism disconnected from the cutting apparatus shown in FIG. 3.

FIG. 16 is a rear perspective view of a cutting apparatus shown in FIG. 13.

FIG. 17 is a plan view of a dual cutting die for use in certain embodiments of the present invention.

FIG. 18 is a flow diagram depicting the operation of a calculation apparatus in accordance with the present invention for use in cutting vertical blinds (louvers only).

FIG. 19 is a flow diagram depicting the operation of a calculation apparatus in accordance with the present invention for use in cutting vertical blinds (complete blinds and headrail only).

FIG. 20 is a flow diagram depicting the operation of a calculation apparatus in accordance with the present invention for use in cutting horizontal blinds.

FIGS. 21-33 are screenshots of a set of standard screens a user will navigate through in accordance with a calculation apparatus of the present invention.

FIGS. 34-41 depict look up tables including the cutdown matrices for different types of blinds in accordance with a calculation apparatus of the present invention.

### DETAILED DESCRIPTION

In describing the preferred embodiments of the subject matter illustrated and to be described with respect to the drawings, specific terminology will be used for the sake of clarity. However, the invention is not intended to be limited to any specific terms used herein, and it is to be understood that each specific term includes all technical equivalents which operate in a similar manner to accomplish a similar purpose.

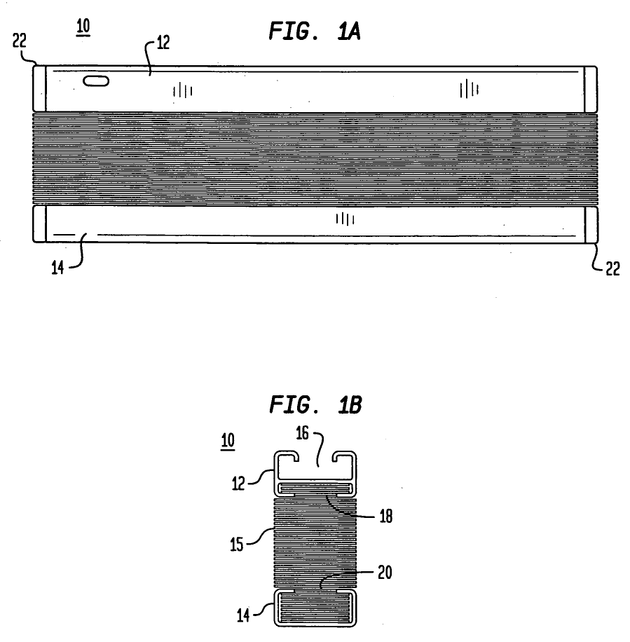

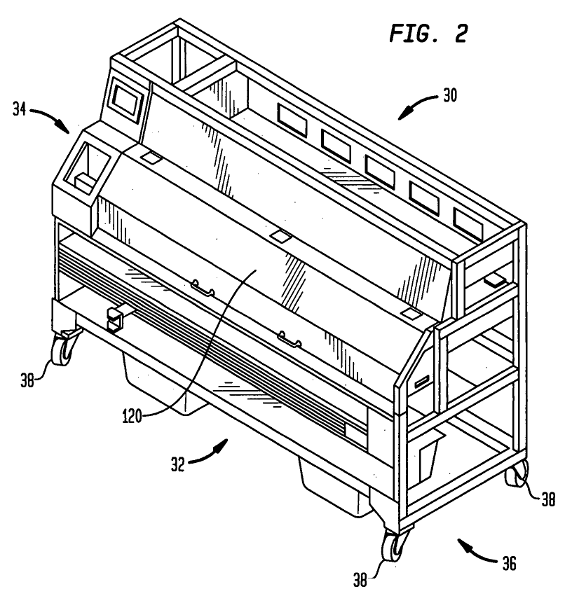

Referring now to the drawings, FIGS. 1A and 1B show one example of the type of window covering 10 that can be cut by the cutting apparatus and methods described herein. However, it should be understood that the invention is not limited to cutting any particular type of window covering or window covering material. One of ordinary skill in the art would recognize that the cutdown machine and methods of the present invention may be utilized in conjunction with many different types of window coverings. Window covering 10, as best shown in FIGS. 1A and 1B, preferably includes a head rail 12, a bottom rail 14 and window covering material 15 disposed therebetween. Head rail 12 and bottom rail 14 may be constructed of metal; however, in other embodiments, head rail 12 and bottom rail 14 can also be constructed from other materials such as extruded plastic material. Similarly, window covering material 15 may be a fabric, such as a point bonded polyester blend material, or may include slats, which are generally constructed of a somewhat flexible material, such as polyvinyl chloride (PVC). Alternatively, the slats can be made from wood or faux wood materials. Head rail 12 is typically has a C-shaped configuration with an opening 16 in a top portion, which may be used for securing window covering 10 to a window opening or for rigging the window covering with control lines. Head rail 12 also preferably includes a lower C-shaped opening 18 for securing a top section of window covering material 15. Likewise, bottom rail 14 also preferably includes a C-shaped opening 20 for receiving and securing a bottom section of window covering material 15.

In certain embodiments, window covering 10 may also include removable end caps 22 at the ends of head rail 12 and bottom rail 14. End caps 22 are configured to stabilize the ends of the head rail 12 and the bottom rail 14 and to improve the overall aesthetic appearance of window covering 10. During a cutdown operation, ends caps 22 are preferably removed before window covering 10 is cut and reinstalled into the open rail ends after the cutting operation. This provides that the ends of the two rails always look the same, and may hide any defects caused on the end faces by the cutting procedure. For example, headrails and bottom rails constructed of metal or wood may be finished on the exterior surface, but when cut away may expose the original color of the material. End caps 22 will cover any such change in color. It is contemplated that end caps 22 may be any shape, as long as they are capable of cooperating with the ends of headrail 12 and bottom rail 14, respectively.

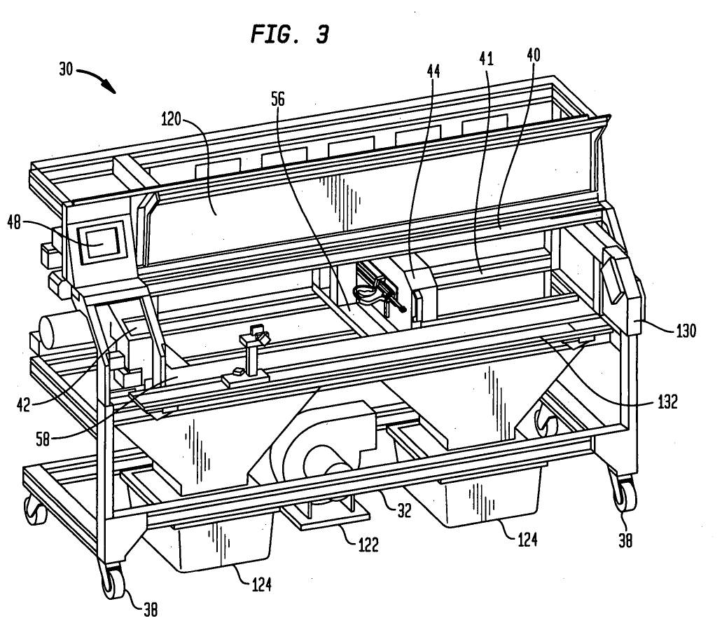

Referring now to FIGS. 2 and 3, a window covering cutting apparatus 30 is shown according to one embodiment of the present invention. Apparatus 30 includes a base 32 having a first end 34 and a second end 36. In preferred embodiments, base 32 further includes rollers 38, which may be in the form of wheels or other mechanisms suitable for moving the apparatus 30. As is best shown in FIG. 3, window covering cutting apparatus 30 further includes upper rails 40 and lower rails 41 extending between first end 34 and second end 36, a stationary cutting assembly 42 mounted at or near first end 34 of the apparatus, and a moveable cutting assembly 44 slidably supported by upper rails 40 and lower rails 41. In a certain embodiments, moveable cutting assembly 44 can be moved between the position near that held by stationary cutting device 42 and that of second end 36. Moveable cutting assembly preferably includes a handle 46 to facilitate manual movement, but may also be arranged so as to allow automated movement of the assembly. According to one or more embodiments of the invention, apparatus 30 further includes a user interface 48 for inputting the desired dimensions of the window covering to be cut. User interface 48 may be in the form of a touch screen, a keypad, or a personal computer with a keyboard and mouse or other input device connected to cutting apparatus 30. Alternatively, the user interface could include a microphone and voice recognition software. This user interface will be more fully discussed below.

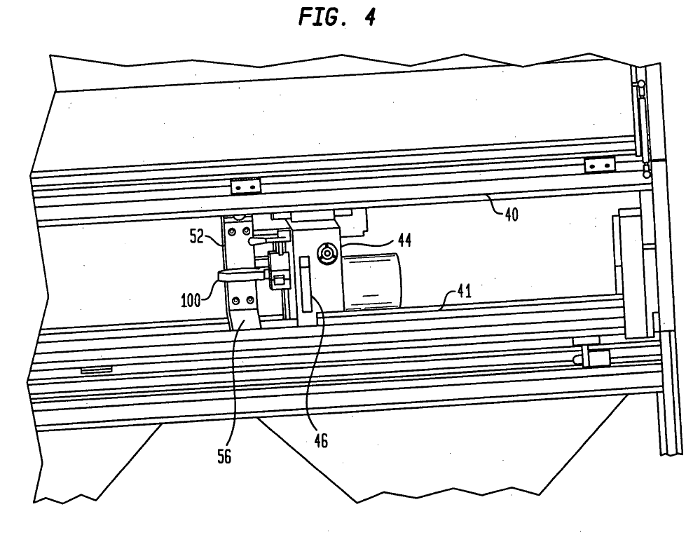

In a preferred embodiment, as best shown in FIG. 4, cutting apparatus 30 further includes a stop element 52 that automatically moves in response to the dimensional information entered through the aforementioned user interface 48, as will be discussed more fully below. Stop element 52 is slidably supported by rails 40 and 41, and is capably of being variably positioned relative to fixed cutting assembly 42. More specifically, stop element 52 is positioned such that the distance between cutting assemblies 42 and 44 may be adapted to be approximately equal to the desired width of the window covering to be cut. Essentially, stop element 52 prevents moveable cutting assembly 44 from being manually moved past a specific location on the rails 40 and 41 in a direction towards assembly 42, and ensures that the cutting assemblies are spaced so that their operation causes the cutting of the window covering, on both sides simultaneously, to the desired dimensions. In certain embodiments, stop element 52 may include an extension arm (not shown), which cooperates with moveable cutting assembly 44 in order to lock the assembly in place prior to the cutting of window covering 10. Additionally, a locking clamp (not shown) may be mounted to moveable cutting assembly 44 that may include a lever which can be engaged with the extension arm so as to more fully lock moveable assembly 44 in place during a cutting operation. It is also contemplated to provide cutting assembly 44 with spring loaded rollers (not shown) that passively lock or keep the assembly in position once it is pulled or butted up against stop element 52.

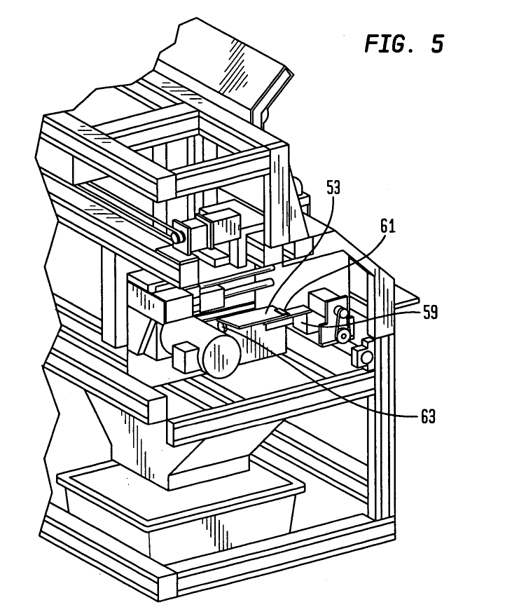

In the embodiment shown, stop element 52 is a substantially L-shaped structure including a substantially horizontal portion 56 for supporting a first end of a window covering during a cutting operation. Apparatus 30 also includes a support element 58 (best shown in FIG. 3) associated with stationary cutting assembly 42 which similarly includes a horizontal portion for supporting a second end of a window covering during a cutting operation. Referring to FIG. 5, in which portions of the apparatus 30 have been hidden to highlight certain components, an end plate 53 is also provided. End plate 53 is connected to a servomotor 59 by hinge 61. During operation, servomotor 59 positions end plate 53 after an operator has entered the relevant dimensions, which will be discussed further below. Essentially, during a cutting operation, a wheel 63 lifts end plate 53 to prevent the saw associated with the stationary cutting assembly 42 from stopping against the end plate 53.

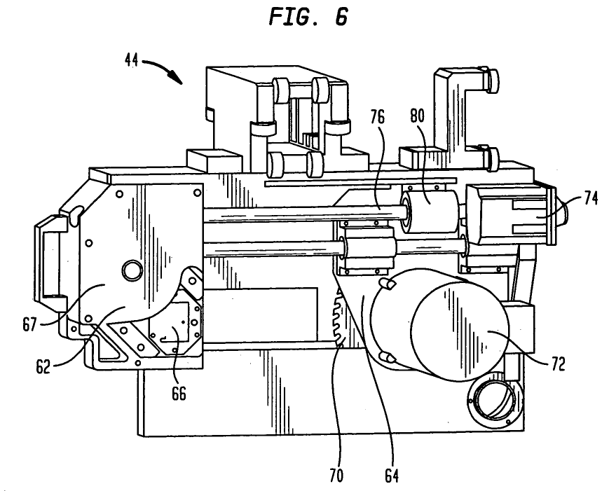

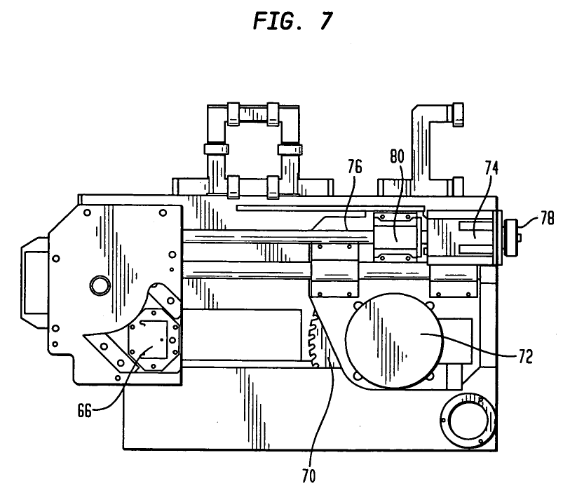

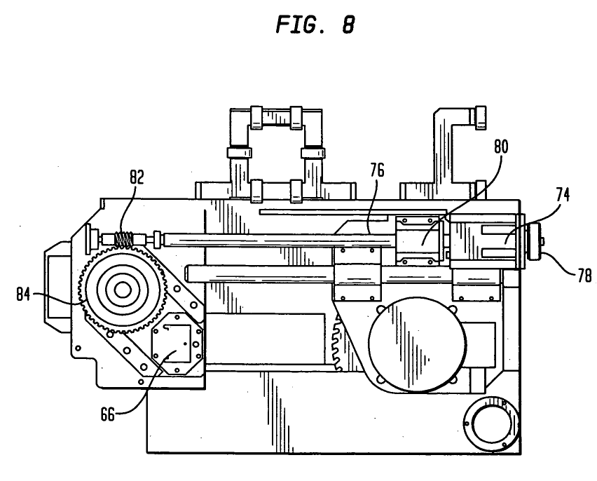

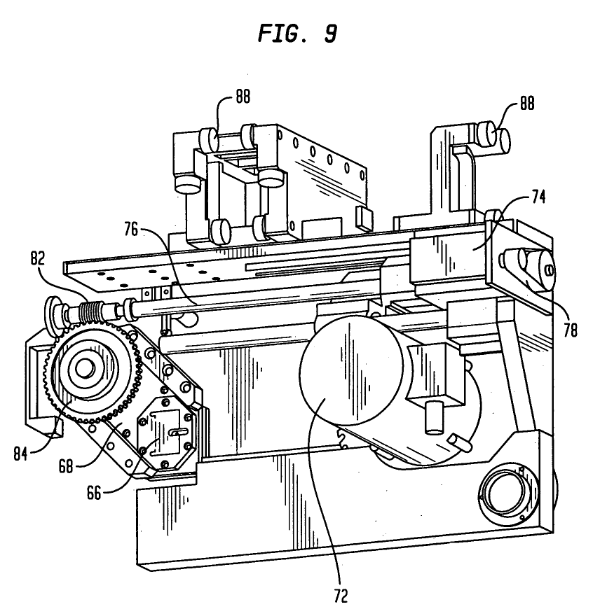

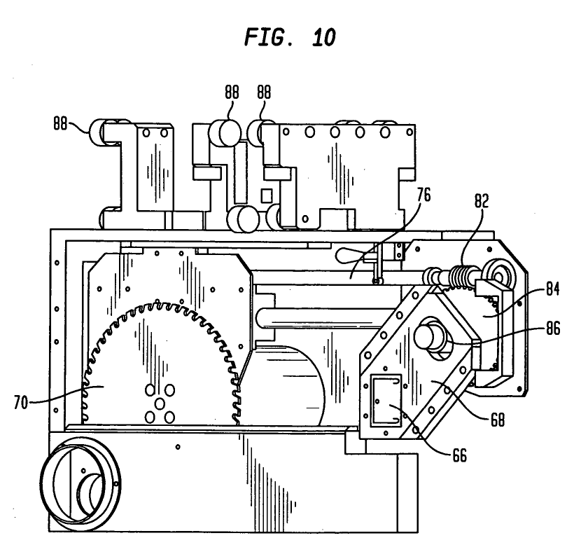

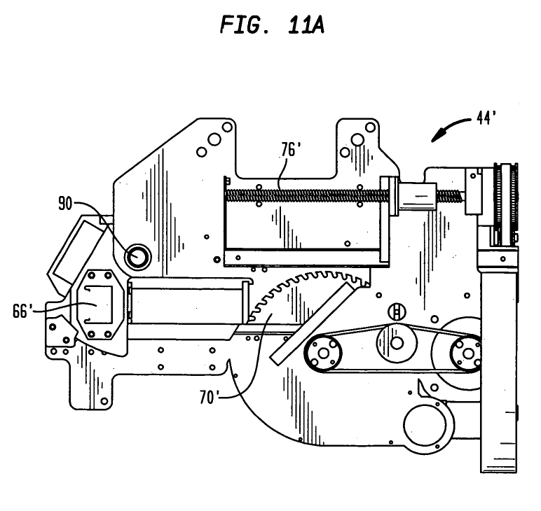

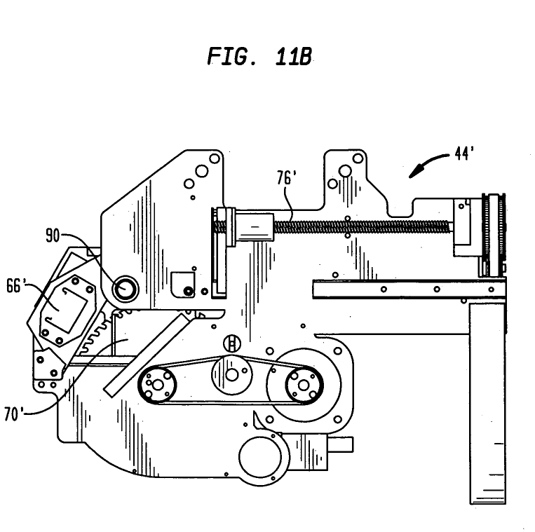

In accordance with certain preferred embodiments of the present invention, moveable cutting assembly 44 is more specifically shown in FIGS. 6-10. In FIGS. 8-10, certain components have been hidden so that the specific components which make up the shear and die can be viewed. As shown in the figures, moveable cutting assembly 44 includes a head rail cutting mechanism 62 and a saw mechanism 64. Head rail cutting mechanism 62 further includes a die 66 and a shear 68 (best shown in FIGS. 9 and 10) in a die enclosure 67. Saw mechanism 64 further includes a saw blade 70 coupled to a motor 72 for rotating the saw blade during a window covering cutting operation.

In the operation according to one or more embodiments, a dual drive mechanism 74 moves shear 68 to cut head rail 12, which extends through die 66, of window covering 10, while also moving saw mechanism 64 including saw blade 70 in a direction substantially transverse with respect to the length of window covering material 15 and bottom rail 14 of window covering 10. The movement of the respective parts causes the simultaneous cutting of the aforementioned elements of window covering 10. Dual drive mechanism 74 can be a suitable motor such as a servomotor or the like. In a completely constructed apparatus 30, dual drive mechanism 74 is coupled to a drive shaft 76 driven by a drive belt 78, which rotates the drive shaft. A carriage 80 carries saw mechanism 64 and travels via a lead screw (not shown) on the drive shaft 76, thus moving saw mechanism 64 in a linear motion so that saw blade 70 cuts through window covering material 15 and bottom rail 14. Drive shaft 76 also carries a worm gear 82 (best shown in FIGS. 8-10) which rotates a rotary gear 84 (also best shown in FIGS. 8-10) that is coupled to an eccentric cam 86 (best shown in FIG. 10). This eccentric cam in turn actuates shear 68 to move in the cutting direction. However, it should be clearly understood that the mechanism described herein is just one example of a drive mechanism that can be used. As would be clear to those of ordinary skill in the art, other mechanisms may be utilized to impart linear motion to saw mechanism 64 while at the same time actuating shear 68.

FIGS. 11a and 11b depict one such alternate design, i.e.—moveable cutting assembly 44′. In this alternate design, the cutting assembly still utilizes a die 66′ and shear 68′ assembly for cutting headrail 12, and a saw blade 70′ for cutting window covering material 15 and bottom rail 14. These cutting components are driven by a substantially similar dual drive mechanism 74′, which operates in a nearly identical fashion to that described above, with similar components utilized throughout. The difference of the cutting assembly shown in FIGS. 11a and 11b lies in the inclusion of a pivot 90 for allowing die 66′ and shear 68′ to rotate in a clockwise/counter clockwise direction. Essentially, during operation, subsequent to the cutting of headrail 12 and upon the approach of saw blade 70′, die enclosure 67′ (housing die 66′ and shear 68′) rotates in a clockwise direction, and results in the position depicted in FIG. 11b. This allows for a portion of window covering material 15, which resides closest to headrail 12 to be cut without contact between saw blade 70′ and die enclosure 67′. The rotation of die enclosure 67′ is particularly important when window covering material 15 comprises slats or the like. It has been found that employing a rotating design such as this allows for the top slats, closest to headrail 12, to be cut without interference between blade 70′ and die enclosure 67′ becoming a problem. It is contemplated that die enclosure 67′ may be rotated through a connection with dual drive mechanism 74′. Upon the successful cut down process, die enclosure 67′ preferably rotates in a counter clockwise position, back to its original position, as depicted in FIG. 11a. It is noted that like reference numerals having an additional prime designation refer to like elements as discussed above in relation to assembly 44.

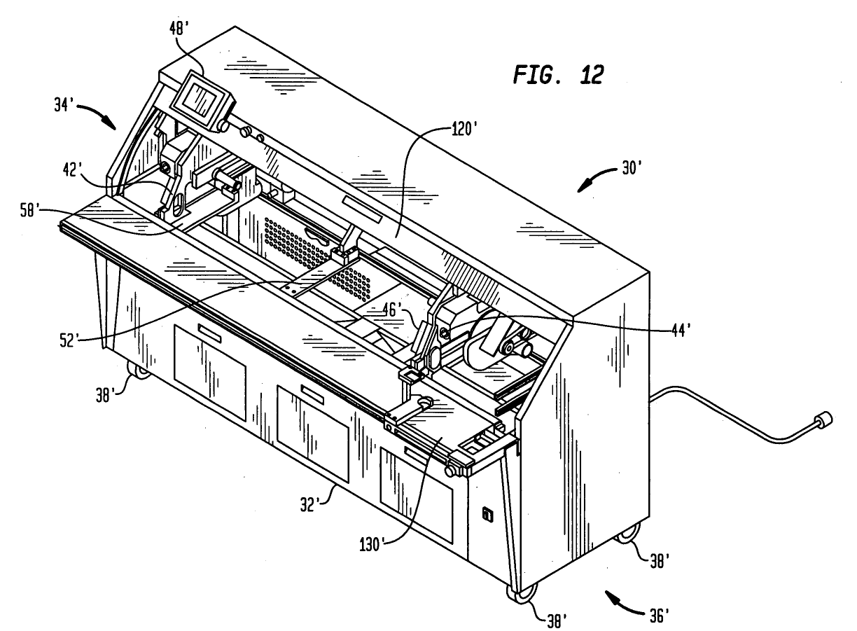

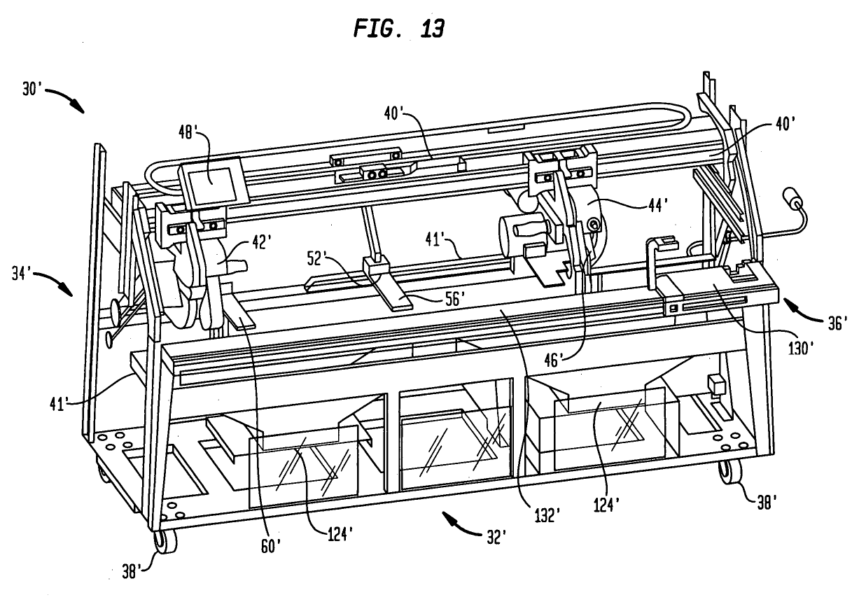

FIGS. 12-14, which are similar in views to aforementioned FIGS. 2-4, depict an apparatus 30′ including the alternate cutting assembly 44′ design described above. Essentially, FIGS. 12-14 depict a second preferred embodiment cutting apparatus 30′, which operates in a substantially similar manner to that of apparatus 30 depicted in FIGS. 2-4. Like reference numerals have been utilized in FIGS. 12-14, for elements which are similar in function and operation to those originally depicted in the figures and discussed above in relation to apparatus 30. However, a prime designation has been given to the like reference numerals for clarity. It is noted that cutting apparatus 30′ shown in FIGS. 12-14 may include like elements that differ slightly in structure, but that operate in the same manner as described above. For example, stop element 52′ of apparatus 30′ includes a slightly different physical construction than that of stop element 52 of apparatus 30. Nevertheless, its operation remains substantially similar. Additionally, cutting assembly 42′, as shown in FIGS. 11a and 11b, operates in substantially the same manner as cutting assembly 44 of apparatus 30, as shown in FIGS. 2-4. However, as discussed above, cutting assembly 44′ includes a rotatable die enclosure 67′.

According to one or more embodiments, stationary cutting assembly 42 includes the same or substantially similar elements to that of assembly 44 or 44′. For example, stationary cutting assembly may be similar to assembly 44, including a dual drive mechanism 74, where head rail cutting mechanism 62, saw mechanism 64, drive shaft 76, drive belt 78, carriage 80, worm gear 82, rotary gear 84 and eccentric cam 86 are essentially the same. Assembly 42 may also preferably operate in substantially the same manner as that set forth above in the discussion of moveable cutting assembly 44. Similarly, the shear and saw mechanisms of the respective cutting assemblies also both operate to cut the head rail and the bottom rail and window covering material substantially simultaneously. It is also contemplated that cutting assembly 42 may be any of the above discussed embodiments of assembly 44, such as assembly 44′. Essentially, the only difference between cutting assemblies 42 and 44 is that cutting assembly 44 is moveable. Typically, moveable cutting assembly 44 is slidably supported on the upper rails 40 of the apparatus 30 by a plurality of rollers 88 (best shown in FIGS. 9 and 10). However, it is contemplated that in certain embodiments, apparatus 30 may include more than one moveable cutting assembly, similar to cutting assembly 44.

According to one or more embodiments, moveable cutting assembly 44 may also include a clamp mechanism 100 mounted thereto for clamping a window covering 10. FIG. 15 depicts clamp mechanism 100 detached from moveable cutting assembly 44. As shown in the figure, clamp mechanism 100 includes a pair of clamping arms 102 and 104. Clamping arm 102 is preferably moveable with respect to clamping arm 104, and is mounted to a shaft 105, which includes a plurality of ratchets (not shown) along its length. In operation, a trigger or other similar actuation mechanism 106 engages a pawl (not shown) with the ratchets, similar to the action of a caulk gun, to advance the clamping arm 102 towards the clamping arm 104. In order to move clamping arm 102 away from clamping arm 104, a trigger release (not shown) releases the pawl from the ratchets, so that the arms may thereafter be moved. Preferably, at least one of the clamping arms 102 and 104 is pivotable so that the clamping arms can be moved out of the way during a loading operation. In certain embodiments, stationary cutting mechanism 42 includes a similar clamp mechanism to that of clamp mechanism 100. Other embodiments in accordance with the present invention may include different clamps or the like, which are suitable for capturing and holding window covering 10. For example, it is contemplated to also utilize a clamp having a racheting pull clamp with a single button release. Such a design is well known in the art.

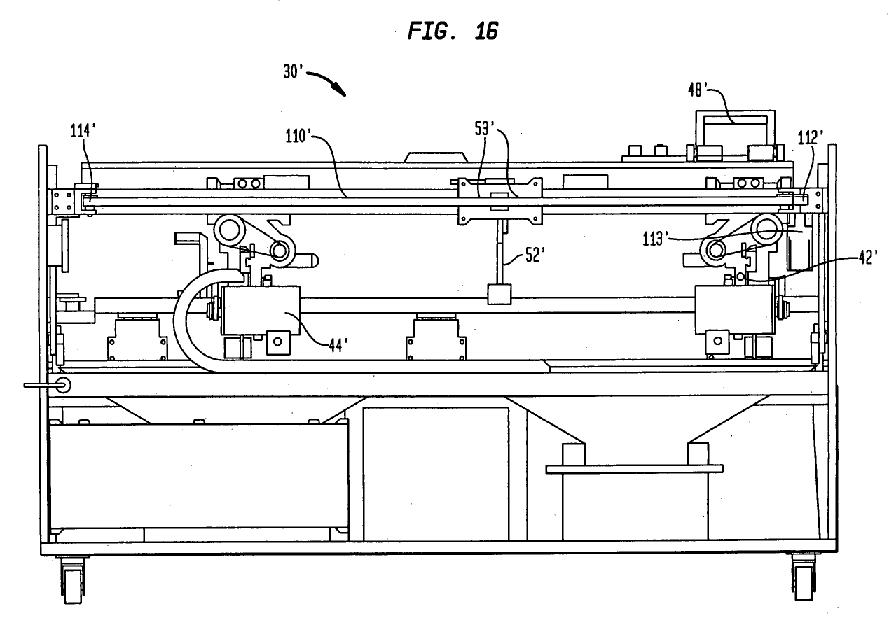

As shown in FIG. 16, cutting apparatus 30 preferably further includes a belt 110 and pulleys 112 and 114, where pulley 112 is connected to a drive motor 113. In operation, rotation of pulley 112 drives belt 110. As belt 100 is coupled to the stop mechanism 52, which is supported by stop mechanism rollers 53 on the aforementioned rails, movement of belt 110 causes movement of stop mechanism 52. In a preferred embodiment, motor 113 is in communication with the above mentioned user interface 48. Thus, after an operator enters the desired dimensions of the finished product into interface 48 or the like, drive motor 113 rotates the pulley 112 an appropriate number of revolutions to drive the belt 110 so that stop mechanism 52 positions in the appropriate location on rails 40 and 41. It is also contemplated to provide a configuration where belt 110 is coupled directly to moveable cutting assembly 44. Such a design would allow for the direct positioning of assembly 44 without the need for manual operation of same. It is noted that FIG. 16 depicts the above described structures in relation to apparatus 30′. However, it is also noted that such elements are similar in structure and function to those included in apparatus 30.

Referring again to FIGS. 2 and 3, cutting apparatus 30 may further include a door 120 for enclosing window covering 10 and cutting mechanisms 42 and 44 during a window covering cutting operation, in order to minimize noise and dust generated during cutting. In preferred embodiments, cutting apparatus 30 also includes a dust containment system including a vacuum 122 and collection bins 124 mounted below cutting mechanisms 42 and 44 and lower rails 41. In operation, collection bins 124 are adapted to collect both dust and large pieces of window coverings cut during a cutting operation. An optional blower and or brush system (not shown) may also be provided to remove dust from the window covering, which enhances the appeal of the finished product to the consumer. Certain embodiments in accordance with the present invention may employ a dust hood (not shown) which moves in relation to moveable cutting assembly 44. This dust hood is preferably a chamber that sits on the side of assembly 44 which expels the scrap from the cutting process. A vacuum hose or the like is preferably attached to the dust hood, so that the aforementioned vacuum may pull scrap/dust through the dust hood and into a collector, like bins 124. With regard to moveable cutting assembly 44, it is contemplated that the dust hood design may be adapted to move along with the moveable cutting assembly. Thus, regardless of the size of the window covering being cut, dust and/or pieces of the covering will be caught by the collection bins associated with moveable cutting assembly 44.

Preferably dies 66, shears 68 and blades 70 of cutting assemblies 42 and 44 are modularly mounted to the cutting apparatus 30. Such modularity facilitates replacement and refurbishment of the tools, so as to prolong the useful life of the cutting machine. In addition, apparatus 30 may further include an auxiliary cutting mechanism 130 (best shown in FIG. 3) mounted on a slide that can be pulled out beyond the frame of the cutting apparatus. This auxiliary cutting mechanism 130 allows longer window coverings such as vertical blinds to be cut by cutting apparatus 30. In certain embodiments, auxiliary cutting mechanism 130 may be a die cut mechanism of the type shown and described in U.S. Pat. No. 6,178,857, the entire content of which has been incorporated herein by reference. Alternatively, auxiliary cutting mechanism 130 may be any other cutting assembly, including the above described cutting assembly discussed in relation to cutting assemblies 42 and 44. This auxiliary setup minimizes the need to provide a completely separate cutting machine for longer window coverings. A shelf 132 that can either fold out or be pulled out beyond the frame of apparatus 30 preferably supports a window covering to be cut in the auxiliary cutting mechanism 130. An auxiliary blind support 134 may also be provided, which may include a clamp (similar to the clamps discussed above) for supporting the blind while being cut in the auxiliary cutting mechanism 130.

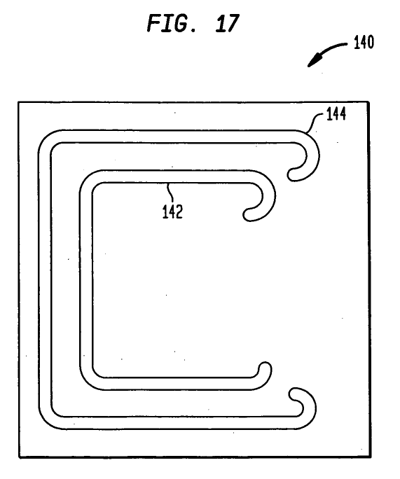

As shown in FIG. 17, a dual die mechanism 140 may also be utilized in accordance with all embodiments of cutting apparatus 30. Such a dual die mechanism includes a body having a smaller die 142 nested within a larger die 144. This design is useful as dual die mechanism 140 will allow differently sized head rails to be cut in the same machine without requiring the step of changing the die used in the cutting apparatus. For example, two popular sized head rails are sized to be one-inch and two-inches, respectively. Dual die mechanism 140 may include smaller die 142 sized to cut the one-inch head rails and larger die 144 sized to cut the two-inch head rails. Other variants are also possible, as would be clearly recognized by those of ordinary skill in the art. According to one or more embodiments, die 140 may be used in any of the cutting assemblies of apparatus 30 described herein.

In accordance with the present invention, it is also contemplated to provide a calculation apparatus or calculator for use during a cutdown operation, or with a cutdown machine such as apparatus 30. In a preferred embodiment, the calculation apparatus receives information relating to desired window covering properties and thereafter determines the above discussed machine settings for trimming/cutting a window covering to the desired size. While it is envisioned that the calculation apparatus may be a stand alone unit for use with any type of cutdown machine, one construction may be similar to the above mentioned user interface 48. As mentioned above and further discussed below, a calculator for use as one example of a user interface 48 is preferably integrated into cutting apparatus 30. Interface 48 preferably includes a screen and a keypad or buttons for allowing a user to input the necessary values while being guided through the process. However, such elements may be configured in any fashion, and may be adapted to fit the particular embodiment of the interface (e.g.—integrated, stand alone, etc . . . ).

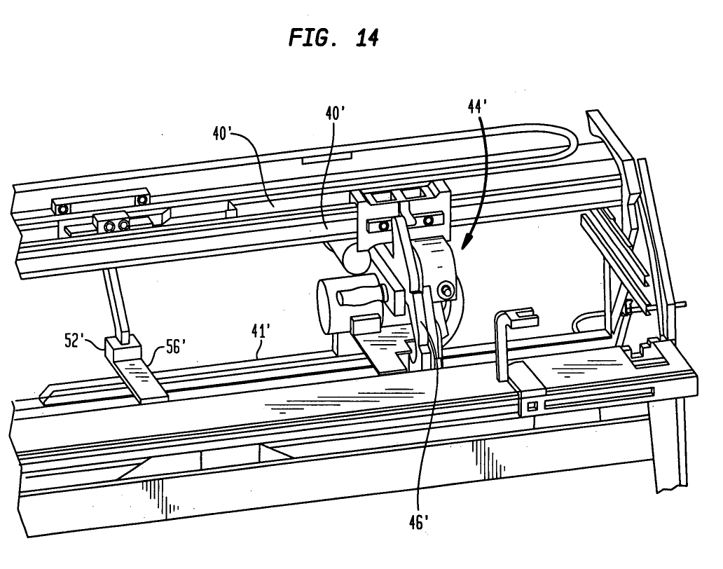

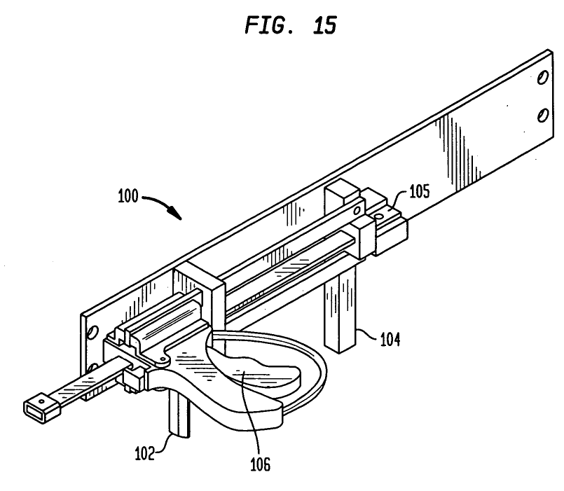

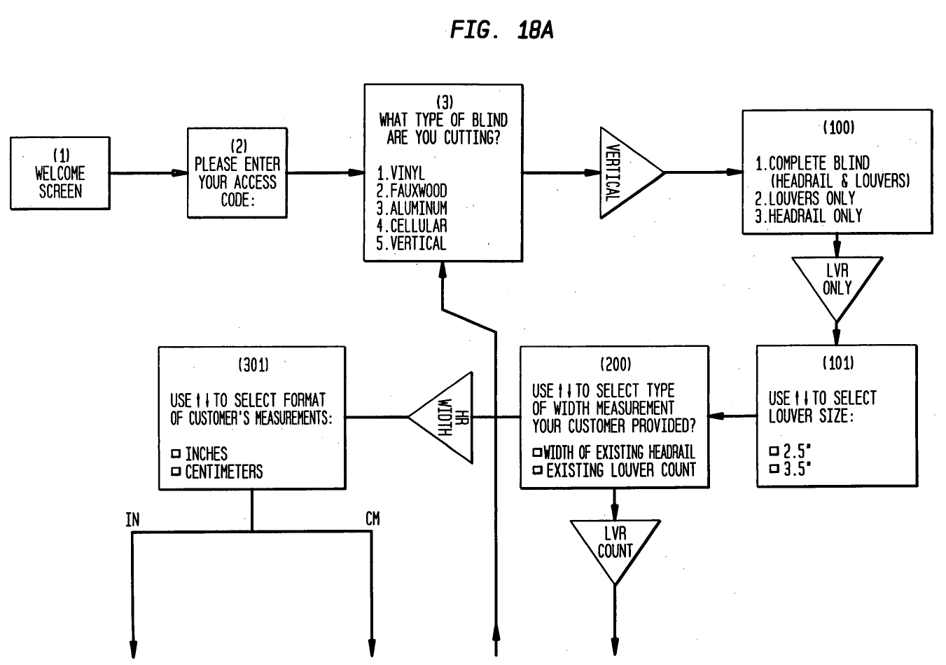

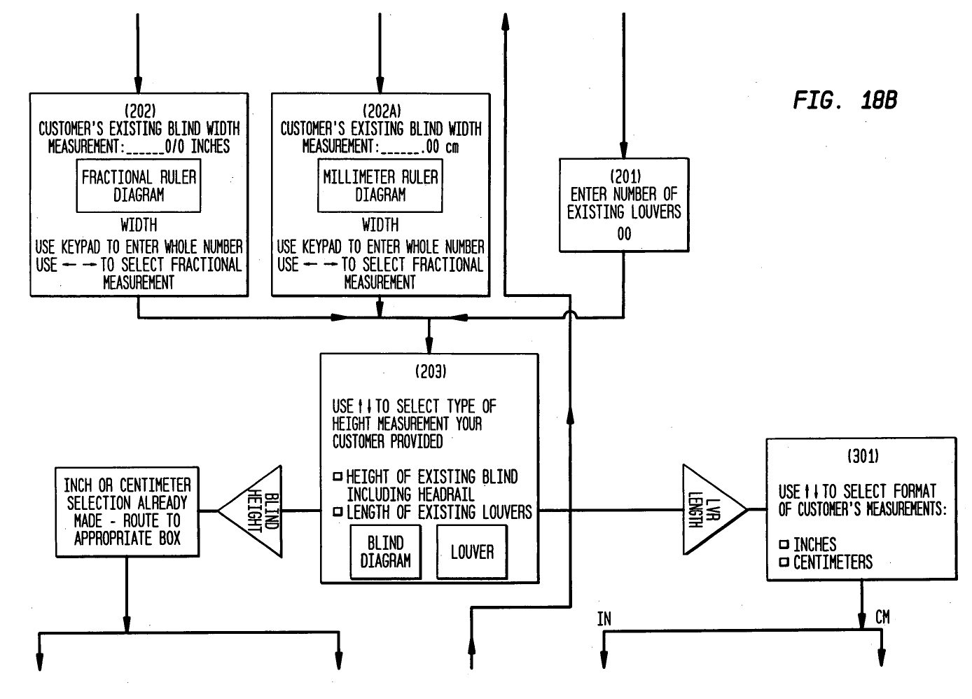

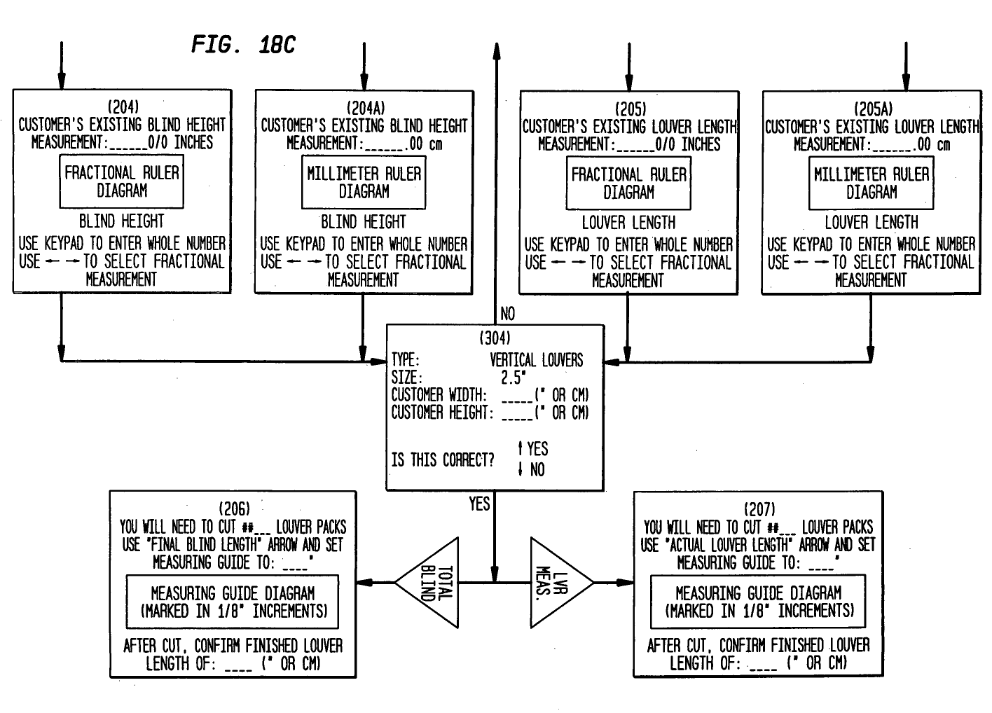

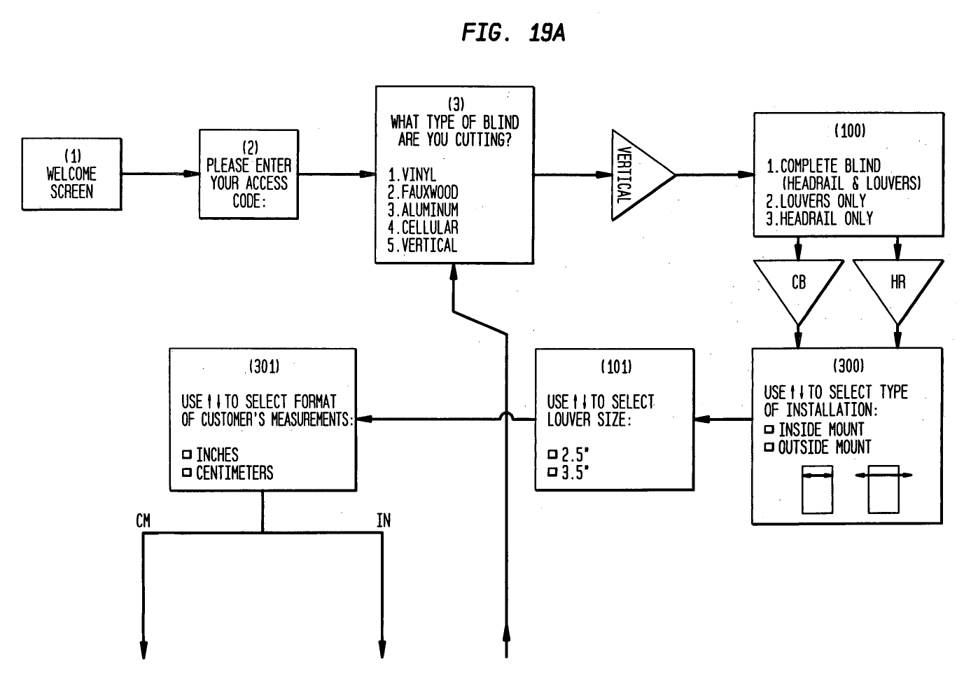

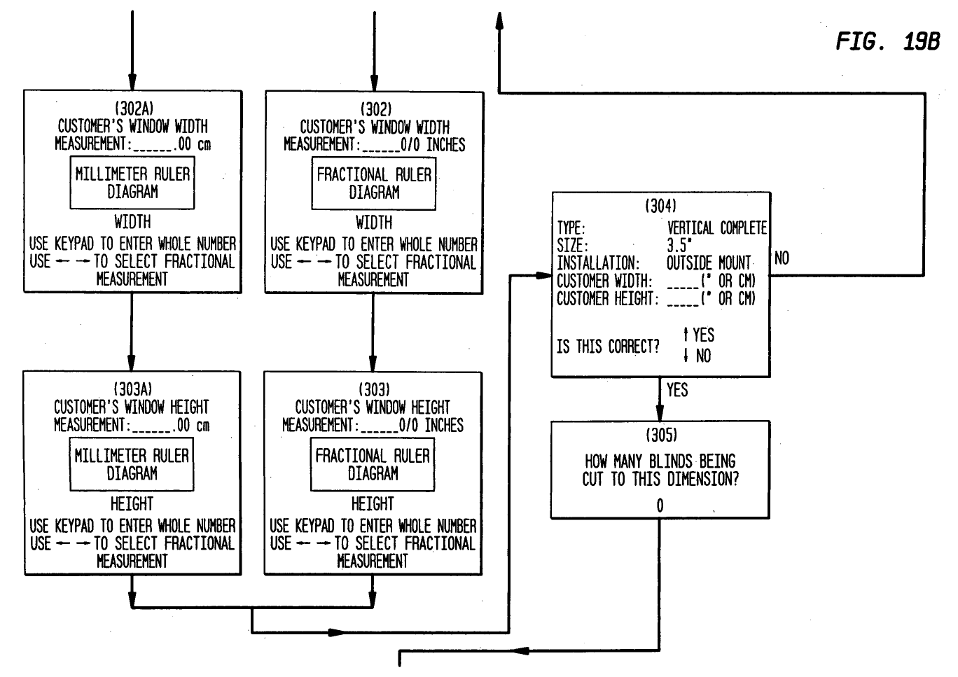

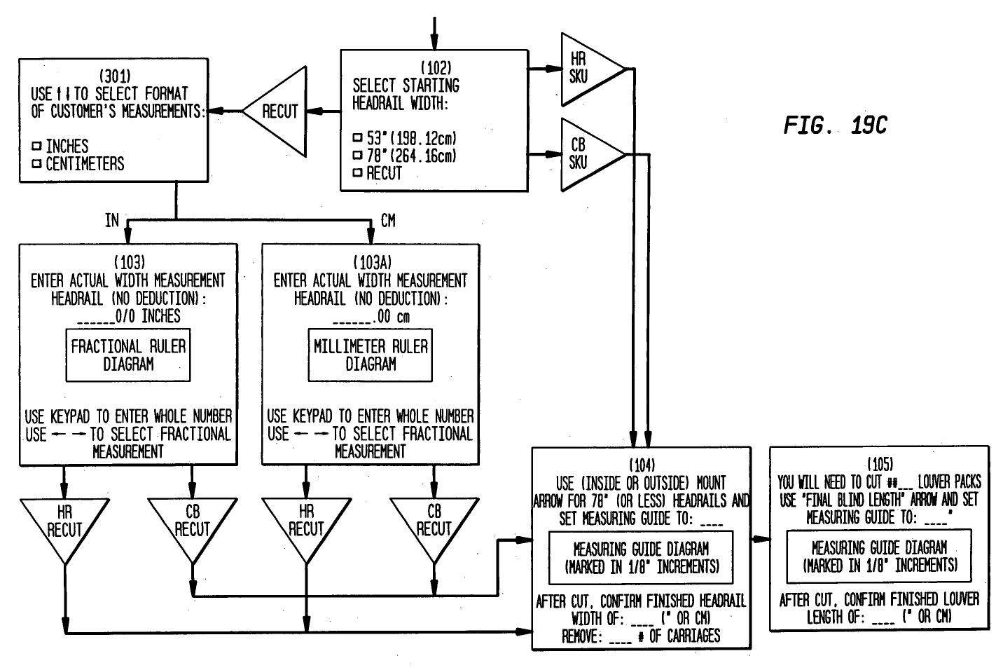

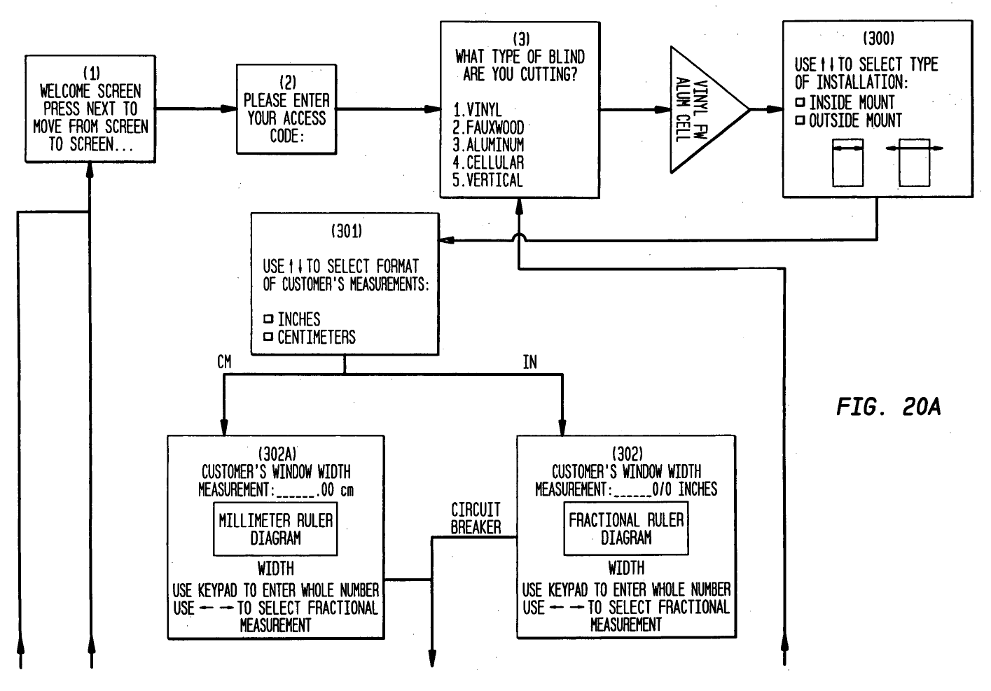

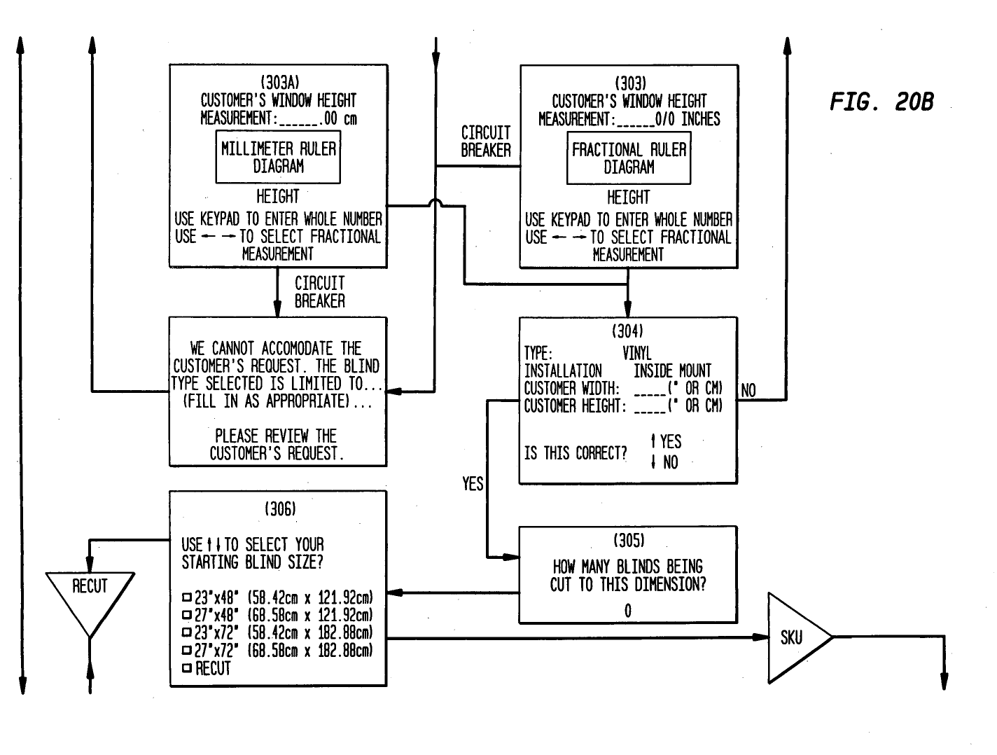

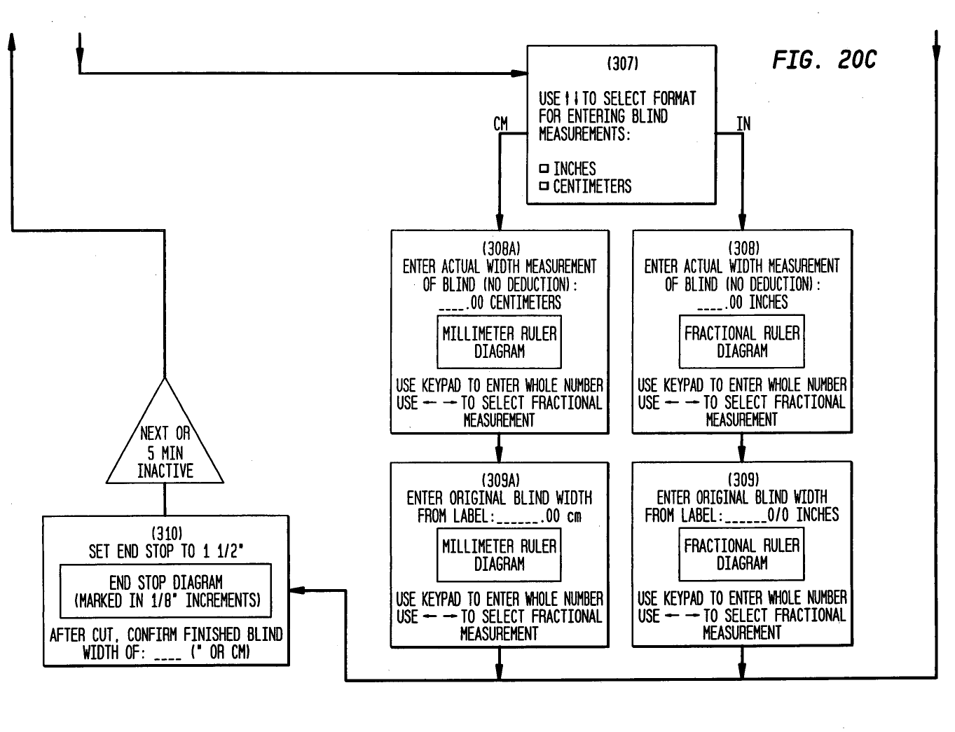

Referring now to the drawings, FIGS. 18-20 show process/screen flow charts, which address substantially all possible scenarios in each of the varying product category cutting processes that the calculation apparatus utilizes. These flow charts outline preferred step-by-step questions and/or requests required to advance entirely through the cutting process calculations, beginning with the type of blind a consumer wishes to purchase, continuing through possible variables, and ultimately to the resulting screen showing the end stop setting for required cut amount. FIG. 18 relates to the cutting of a vertical blind, louvers only; FIG. 19 relates to the cutting of a vertical blind, complete blind and headrail only; and FIG. 20 relates to the cutting of horizontal blinds. In accordance with a preferred embodiment of the present invention, the calculation apparatus is preferably run by custom designed software code substantially in accordance with the process/screen flow charts depicted in FIGS. 14-16, referencing the cutdown logic to take the store associate through every step of the cutdown process. The apparatus provides a store associate or customer interaction with the input of information (via a keypad or the like) regarding the consumer's desired window blind purchase.

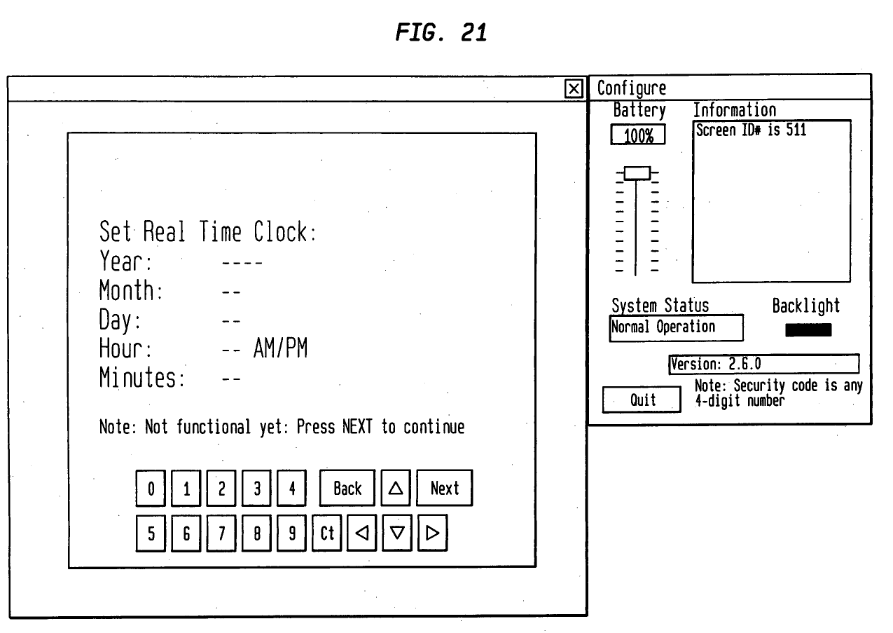

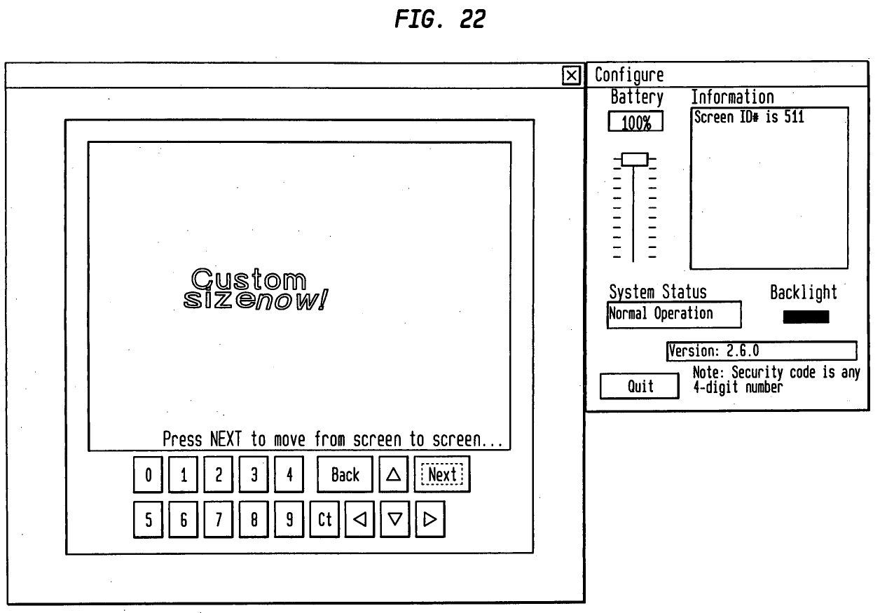

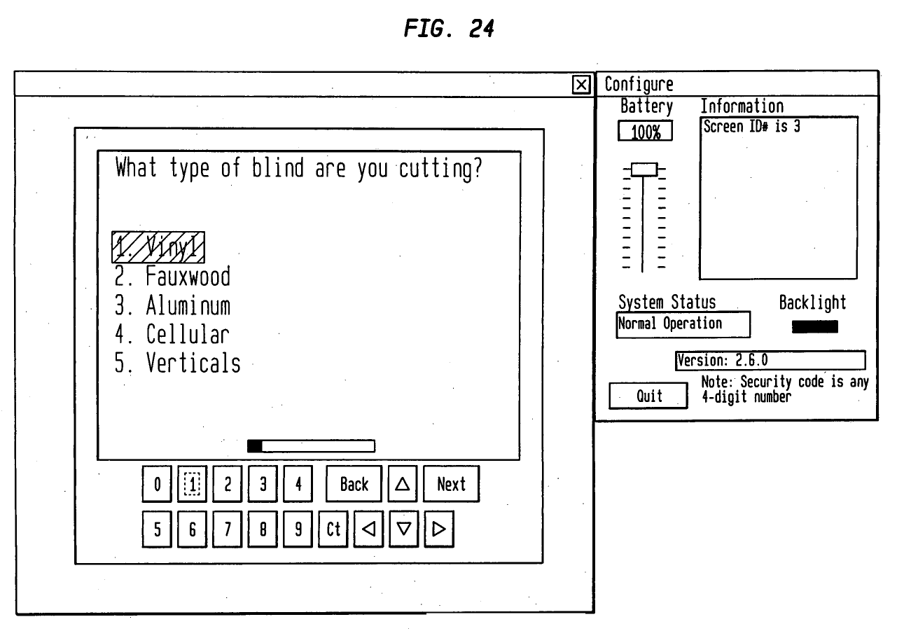

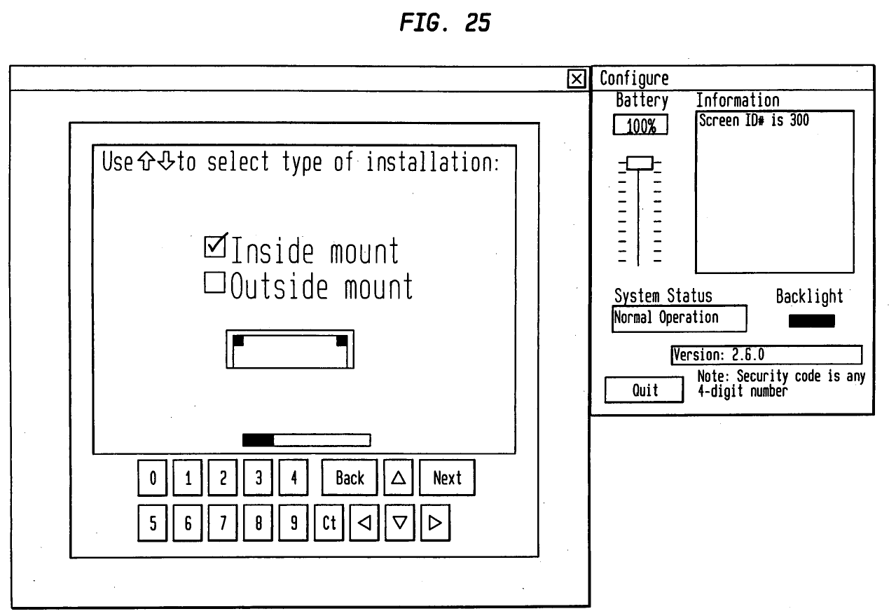

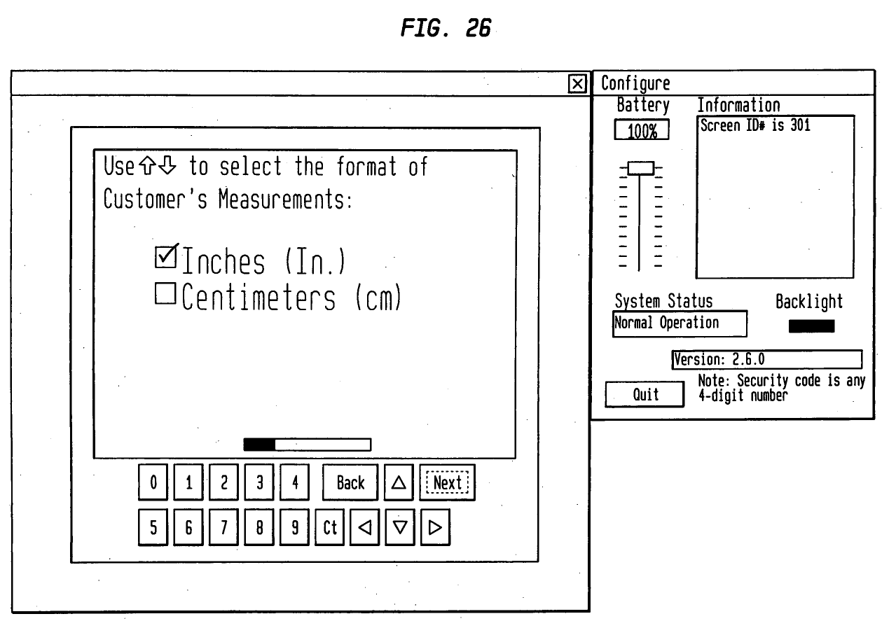

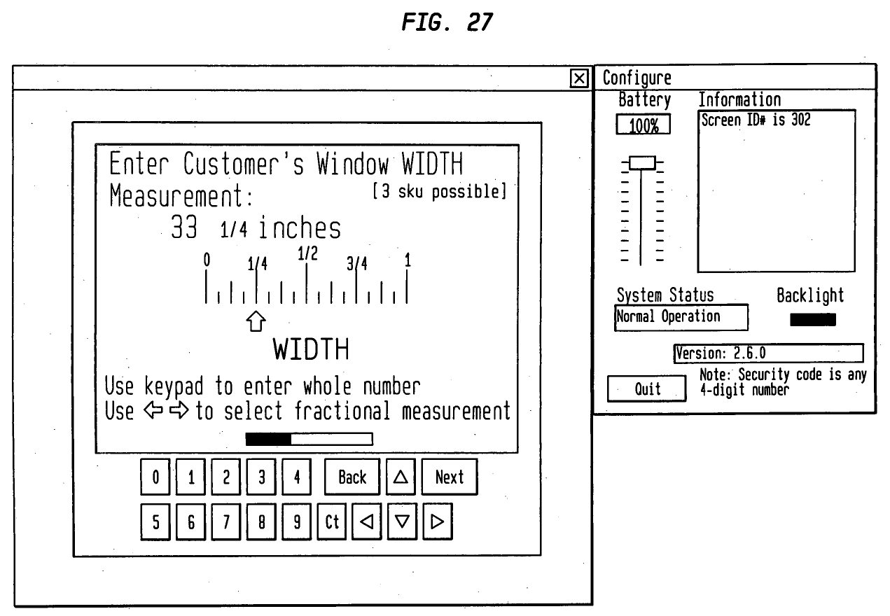

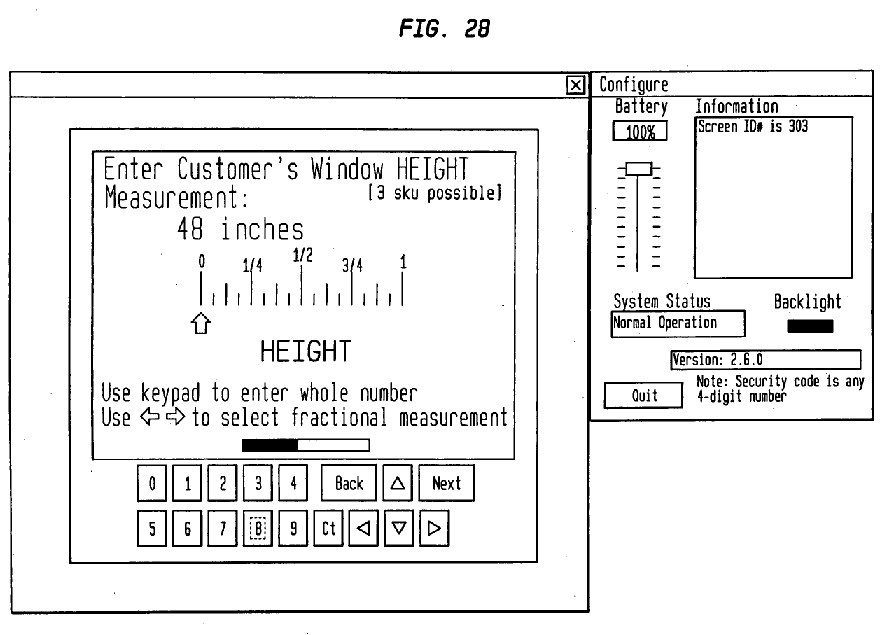

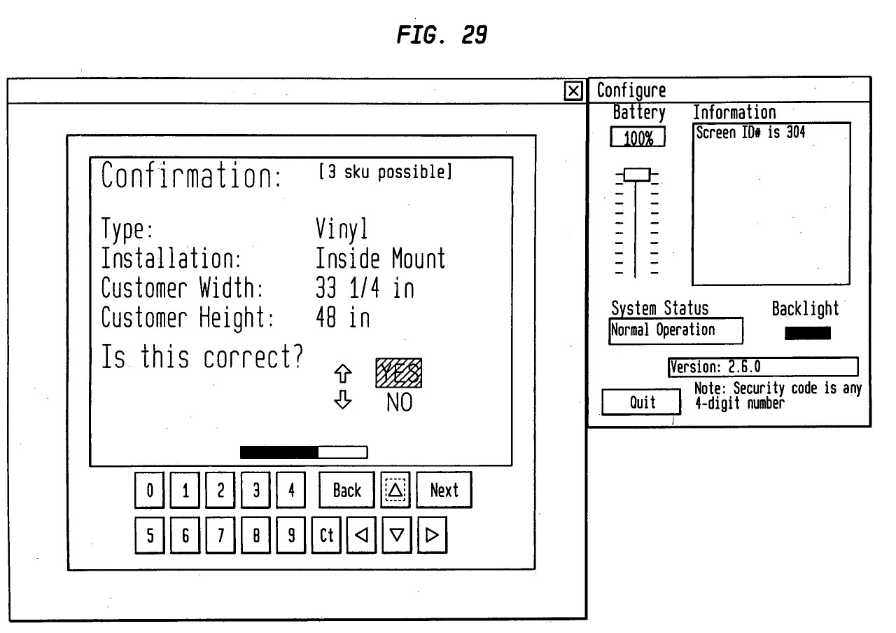

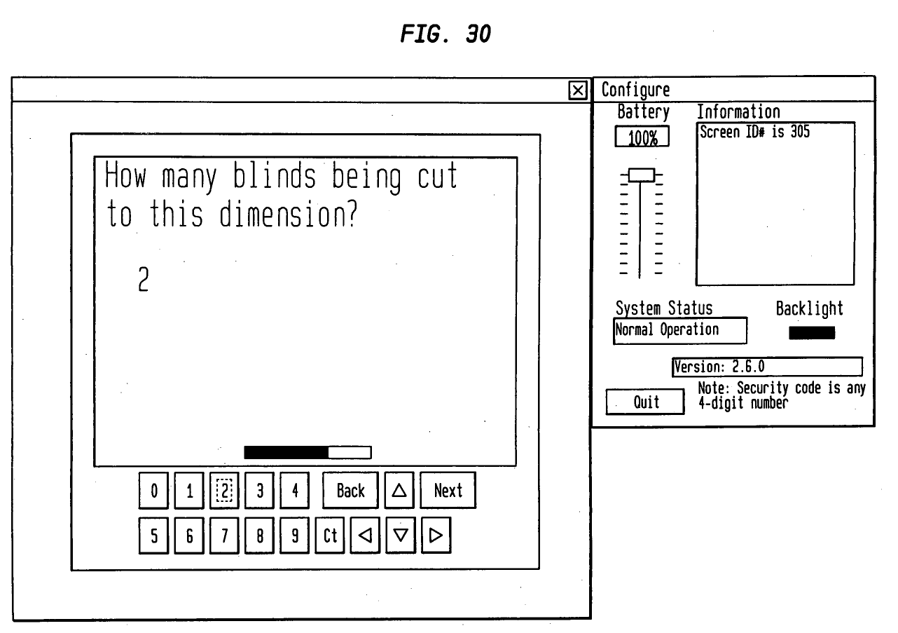

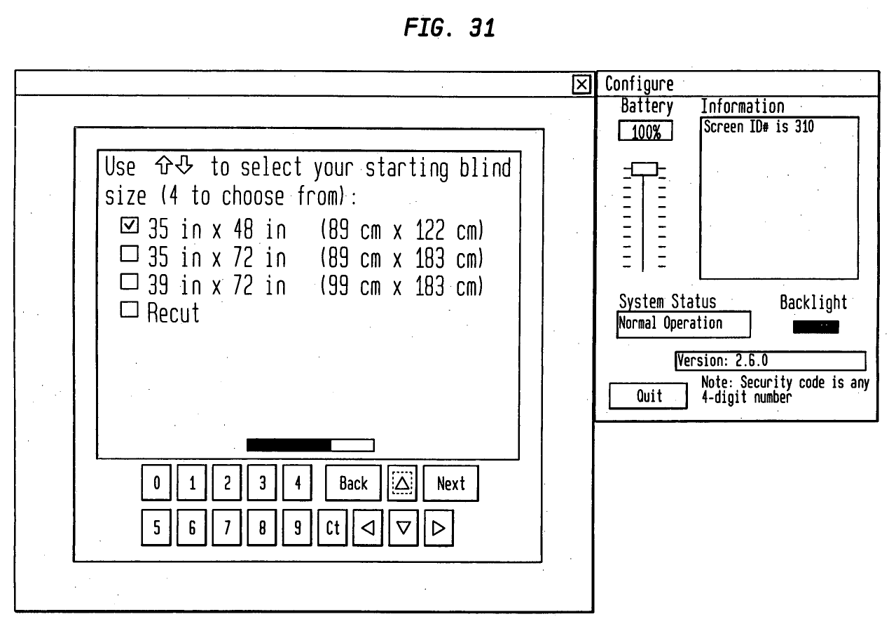

FIGS. 21-33 are examples of screen pages of a preferred method and apparatus of the present calculator invention. These figures depict screens which would be displayed to a user during the operation of an entire step by step calculation procedure for determining the desired trimming/cutting values. Initially, a welcome screen or the like may be displayed, as shown in FIG. 22. After beginning the process, a user may first be asked the specific type of blind for which the cutting process is desired to be performed upon (FIG. 24). Next, as shown in FIG. 25, the user may be asked whether the desired window covering is to be mounted on the inside or outside of the window frame. The screen may include a graphic depiction of an inside vs. outside mount installation, which is provided for easy understanding and correct selection. Next, a user may be asked whether he or she would like to provide values and receive values in English units or Metric units (FIG. 26). Thereafter, a user may be asked to enter the relevant measurements of their window (i.e.—width and height). As shown in FIGS. 27 and 28, a ruler or other visual system of entry of fractional measurements may be provided, which eliminates the need for the store associate to read a physical tape measure or ruler. Once all of the necessary values/answers are entered, the apparatus may require confirmation of all data entered as a final check for the store associate (FIG. 29). In addition, the calculator may inquire as to the number of blinds or window coverings to be cut (FIG. 30). Based on the data entered, the apparatus performs certain calculations and thereafter, as shown in FIG. 31, recommends starting blind sizes currently in the assortment and allows a user to select same.

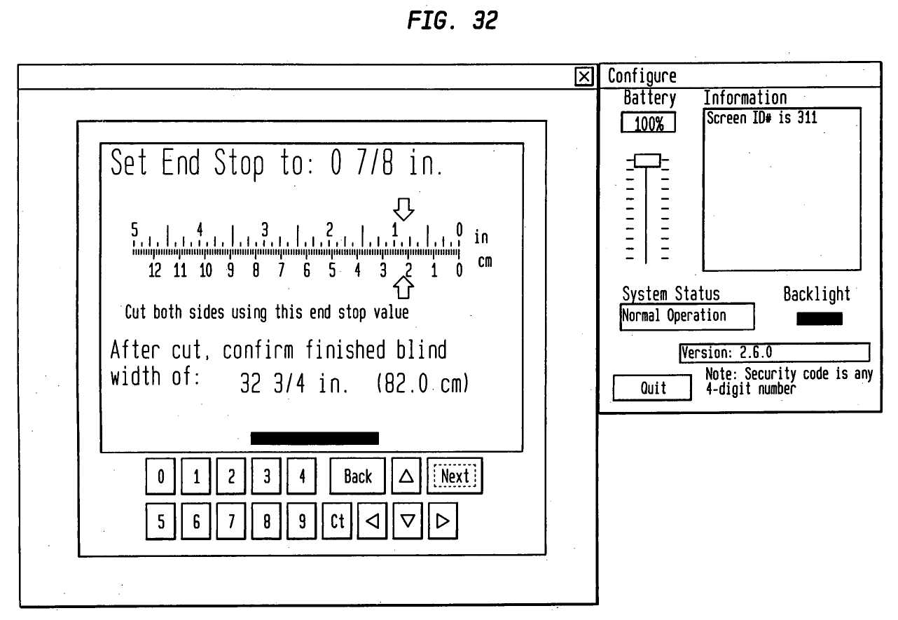

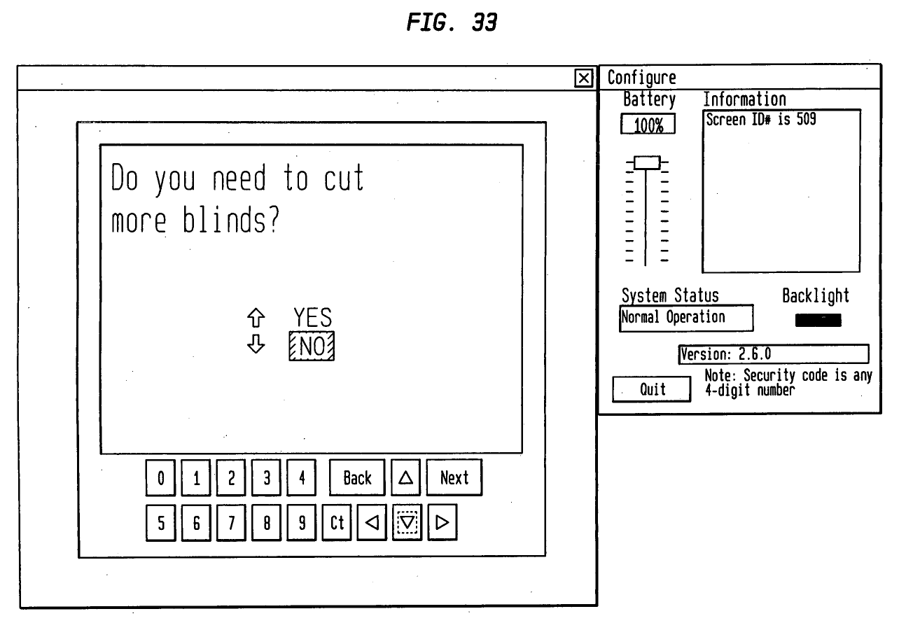

Upon the successful entering of all of the above required information, the apparatus preferably graphically displays the appropriate machine end stop setting(s) and informs the store associate to cut from one side or both (FIG. 32). This clearly depends upon the type of cutdown machine being utilized. The machine end stop setting graphics may be designed so as to match as closely as possible to each different machine. This alleviates the need for the sales associate to take an end stop value and read a ruler to determine where on the ruler that end stop value would appear. Alternatively, the end stop value can be sent to the cut down machine as a signal to automatically set the end stop and provide the proper placement of the window blind for trimming. For example, apparatus 30 includes user interface 48, which is essentially one embodiment of the above described calculator. Upon the successful entering of information via interface 48, a signal is sent to motor 113 to cause same to operate a specific number of revolutions, thereby properly positioning end stop 52. This is briefly discussed above with regard to the cooperation of user interface 48 and motor 113. Preferably, the signal is sent to motor 113 via a serial port connection therebetween. However, it is contemplated that other connections may be utilized. Finally, as shown in FIG. 33, an end screen may be shown, which asks the user whether or not more blinds should be cut.

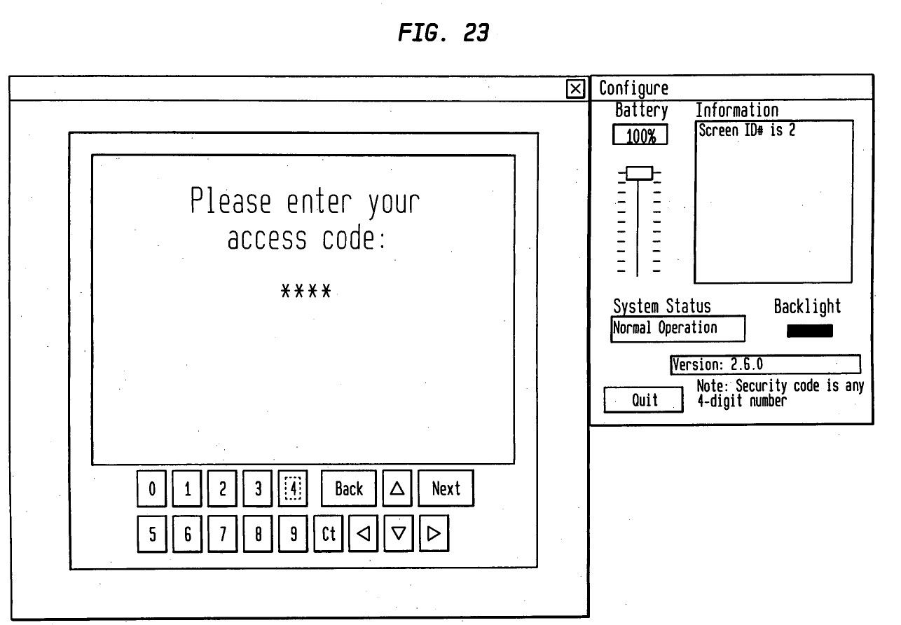

In addition to the above screens/steps, the calculation apparatus may also include a security setup for representatives to access and download data relating to date and time of cuts, store #, type of blind cut, how many cut, and to what measurement (FIG. 21) and which requires a user to enter a pin number or password (FIG. 23). Such may be important in keeping track of inventory or the like, and preventing unauthorized users from operating the machine, respectively. Similarly, the apparatus may be tied into existing inventory or stocking systems so as to provide real time information to a user. For example, the starting blind sizes depicted in FIG. 31 may be taken directly from existing inventory, thereby only displaying those blind sizes which are currently in stock. Another feature that may be provided on the security menu is a “sku maintenance” screen. This feature allows sku's to be added/deleted from the available assortment of blinds. Under sku maintenance, security access will also allow company representatives to update the product assortment and store access codes in the field. In addition, the security screen may include an option that would allow a manager to change the security access so that in the event of a turnover of representatives, there is protection.

A preferred user interface 48, including a calculator of the above type, may be integrated into apparatus 30 so as to include a visible screen and an operable keypad on the face of the machine. In a preferred embodiment, the keypad may consist of keys 0 through 9, back, next, clear, escape, up/down arrows, and left/right arrows, as well as any other keys necessary to perform the preferred methods described above. Alternatively, a preferred stand alone apparatus may be provided. One example of such a stand alone apparatus includes a sturdy housing approximately 10″×10″, a LCD display (between about 5″-7″ wide and 3″-5″ high), an elastomer/membrane covered keypad with tactile response, electronics board(s), driver chips, ROMs, power converter modules, cabling and connectors, possible Flash Media card slot or other type of data port, and all other required hardware. One of ordinary skill in the art will appreciate the other required hardware needed. A stand alone apparatus may be hard-wired for electrical power supply, while an integrated model may be wired to the power supply or power wiring of the cutdown machine. It is also contemplated to provide a battery powered stand alone unit for wireless applications or easy transport around a store or warehouse.

In certain embodiments the calculator may include certain features described hereinbelow. For example, the calculator may include an integrated keypad and label, or switches behind the label. It is also contemplated to provide a calculator, such as user interface 48, which employs a touch screen instead of a keypad. One such physical design for use in accordance with the present invention is a unit sold by Advantech under the model number distinction TPC-642SE. Such a unit may be reprogrammed to perform in accordance with the present invention. In stand alone units, the apparatus may be constructed as a wall module that delivers approximately 24 volts DC on the output (less than 10 watts).

As discussed above, the apparatus may be integrated into a cutdown machine like apparatus 30, or remote from same, where it may communicate via telecommunication channels. For example, the calculator may be configured to communicate in several different fashions, including line of site infrared, remote twisted pair copper wires at normal frequencies or through DSL technology, optical transmission, radio frequency, satellite transmission, 900 Mhz, 2.5 GHz, and the like. The communication between a stand alone apparatus and the cutdown machine may be by way of the Internet or other communication network such as a LAN, WAN or similar networking media. It is contemplated that different stand alone units may be provided for use with different existing or future cutdown machines. However, it is also envisioned that one stand alone calculator may be useful for use with many different cutdown machines. In certain embodiments, it is contemplated that an integrated calculator may also communicate with a cutting machine in many different fashions. For example, interface 48 may be hard wired to apparatus 30, or may be in communication through other means, such as wireless or infrared communications.

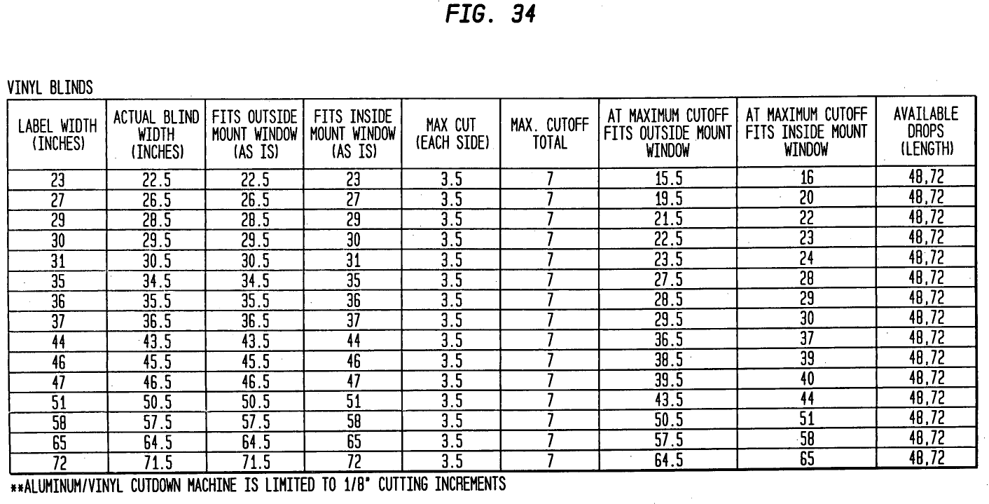

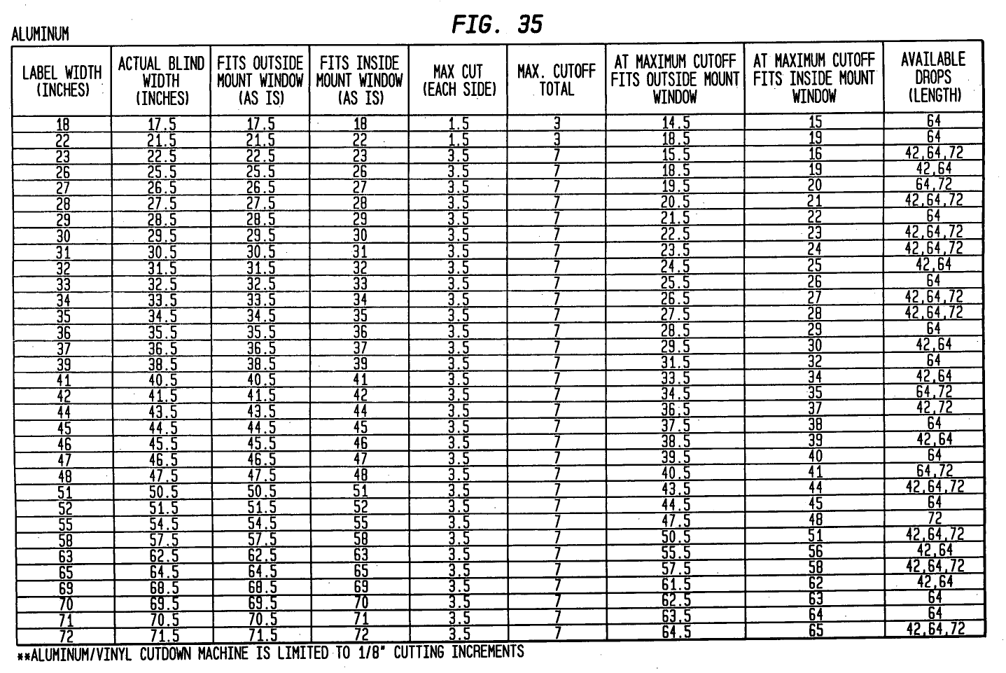

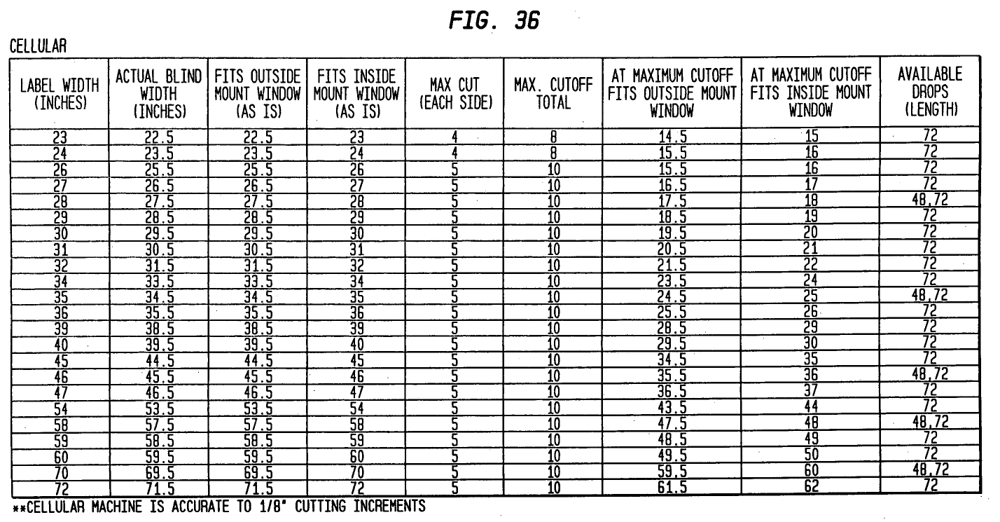

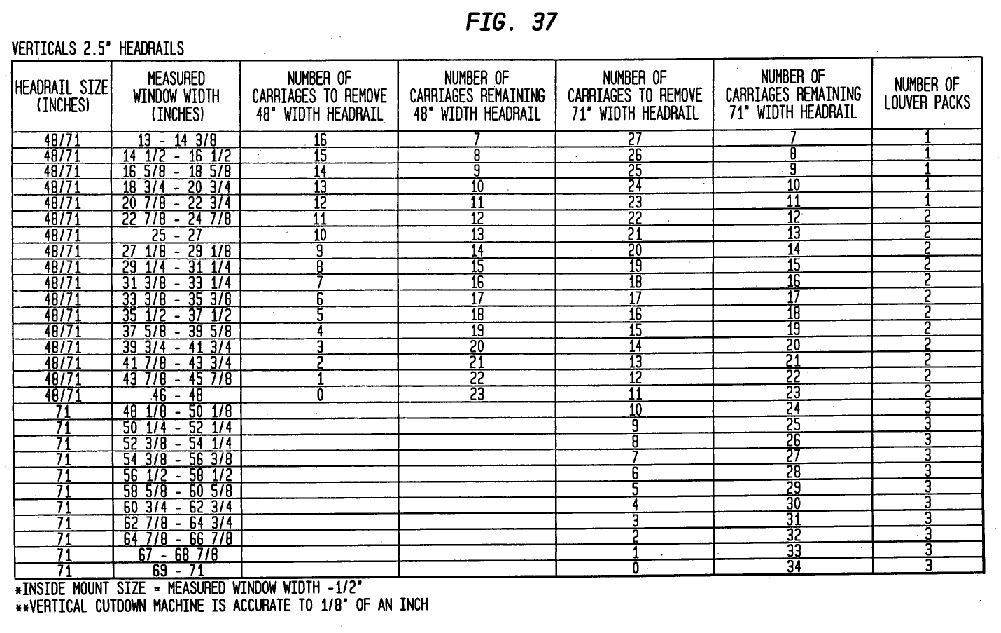

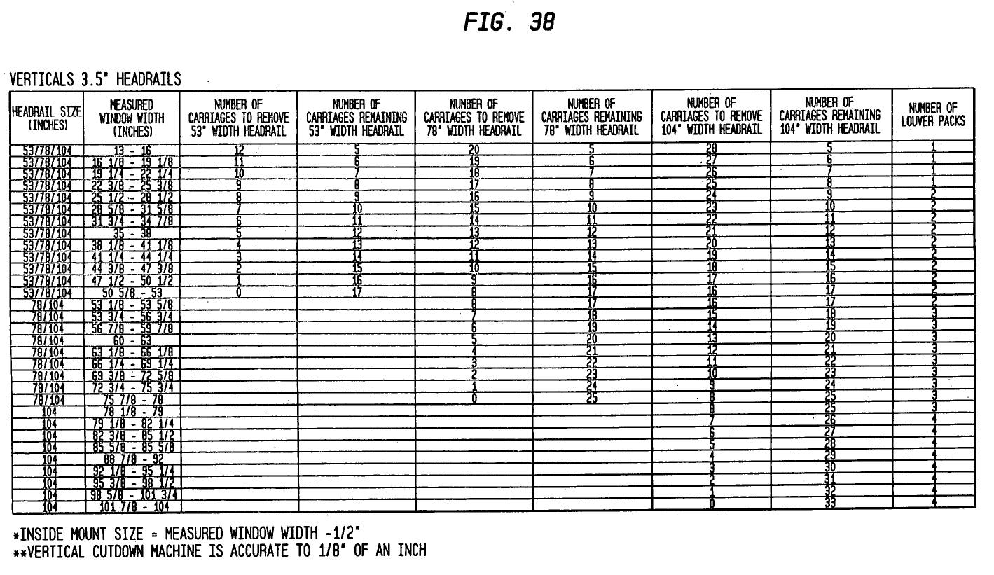

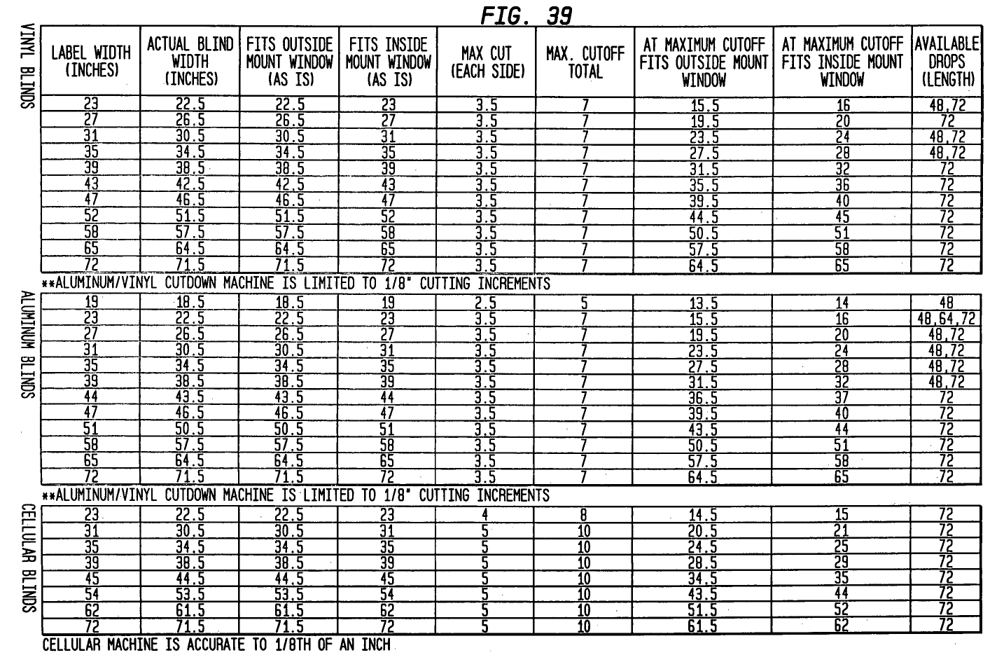

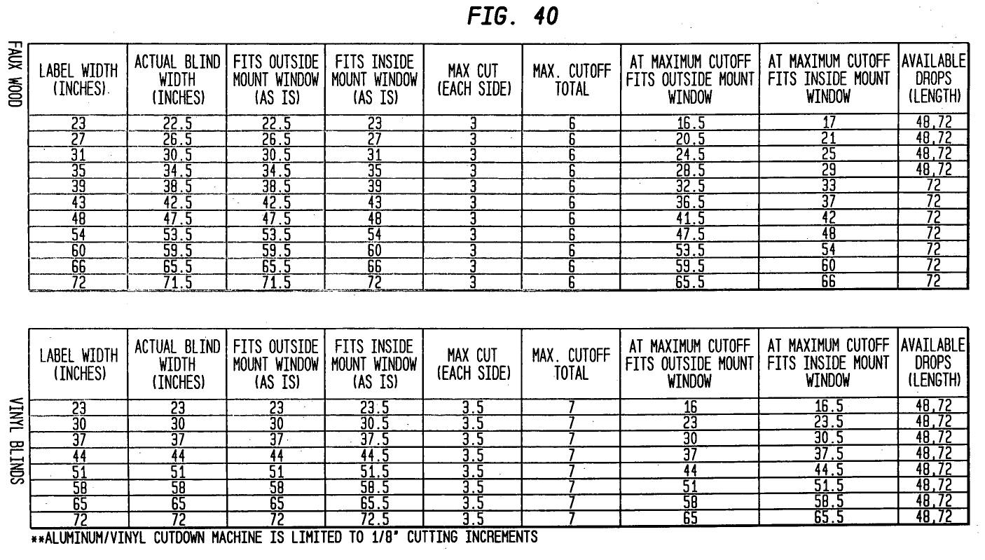

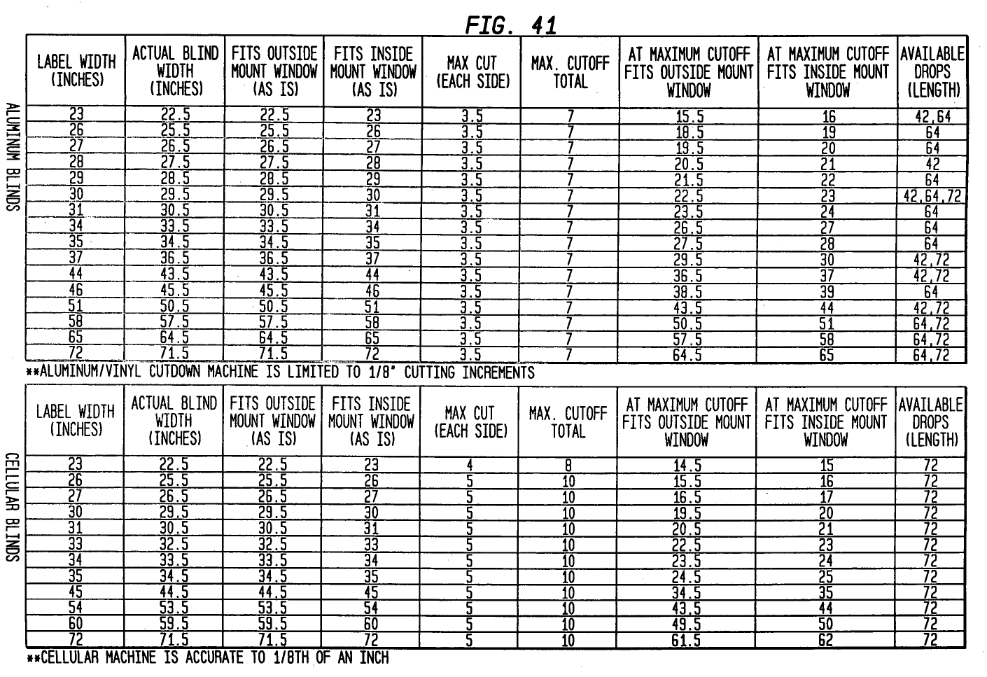

Turning now to FIGS. 34-41, the calculator preferably utilizes look-up tables comprising cutdown logic matrices showing dimensions for various categories of several different styles. Such styles include but are not limited to vinyl, aluminum, cellular, fauxwood, vertical having 2.5″ headrails, vertical having 3.5″ headrails, and the like. The look-up tables are preferably used by software code logic as references for performing the trimming/cutting calculations. The basis of the window blind cutdown process is that the logic matrices which chart blind sizes (by customer), the labeled blind width, the actual blind width, the window fit if purchased as is (inside and outside mounts), the maximum cutoff amount from each side of the blind, the total maximum cutoff amount, the window fit at maximum cutoff (inside and outside mounts), and the height(s) the blinds are offered in, is what the software code references to perform cut calculations.

A preferred embodiment of the apparatus may also include built-in “circuit breakers” if the desired blind purchase falls outside of the program offering. For example, the height measurement entry screen may default to a circuit breaker screen if the height entered is over 72 inches. A typical circuit breaker screen can read:

“Our cutdown program cannot accommodate the customer's request. The blind type selected is limited to ______ . . . . We can accommodate the customer's request with a Bali or Graber Special Order blind.”

As another example of a circuit breaker screen, when a requested measurement is too small, the screen may read (e.g., for an aluminum blind):

“The blind type selected is limited to 13½″ minimum width.”

Clearly other variations capable of being understood by those of ordinary skill in the art are contemplated by the present invention. Preferred embodiments of the apparatus may also be customized to a different array of products sold by each customer serviced by a company and may offer the store associate a list, in preferential order, of starting blind sizes to choose from. The apparatus preferably displays the numerical cutoff amount and also graphically shows the cutoff end stop setting so the associate simply has to visually match what is seen on the screen.

The calculation apparatus in accordance with the present invention may also vary in other embodiments. As mentioned above, measurements may be entered either in English or Metric units, which is a benefit to many store associates who are more familiar with the Metric System. English, Spanish and other language options may also included. In accordance with certain embodiments, the screens, questions, and steps of the process may be changed at any time, as well as the logic matrices and the customer assortments. The software code may be updated, via any connection such as an internet or WIFI connection. The hardware technology used may also be updated or changed. Other variations of the calculator may include touch-screen operation instead of keypad operation, and battery power instead of hard-wire provided power. The apparatus may also be altered to accommodate a card reader system for consumer self-service cutdown blinds in conjunction with a next generation cutdown machine, and the software code may be edited to accommodate Internet ordering.

In a preferred embodiment, the calculation apparatus may include detailed instructions for performing the necessary measurements and/or cutting steps. For example, the calculator may be provided with pop-up instructional windows which explain and/or illustrate the various procedures. Such instructional windows may be accessed through the actuation of a special help button or the like. Similarly, the calculator may also be useful in protecting the use of a cutdown machine. The above mentioned pin number or password protection may be applied to different areas of the machine. For example, a user may be required to enter a pin or password in order to open door 120 of apparatus 30, access auxiliary cutting mechanism 130, or to start the cutting process. However, it is contemplated that other operations of the machine, as well as operation of the calculation apparatus, may be protected. It is also contemplated that different codes may be provided for different of these features.

The calculator apparatus described herein simplifies the complicated cutdown process beyond any previously known solutions. The apparatus requires only basic knowledge to operate. As such, there will typically be minimal training required for store associates to be able to use the apparatus. The apparatus requires verification of all entries before proceeding to starting blind selection, so as to minimize mistakes. Additionally, the apparatus may assist a store associate in re-cutting blinds that were previously cut, thereby minimizing the build up of mistakes caused by mis-cuts. Such is useful in making full use of in-store inventory. It should be clear from the foregoing that the aforementioned calculation apparatus may be useful in both automatically setting a stop member or the like (when integrated or in communication with a cutting machine), as well as providing a position at which such could be manually set. The latter may be more clearly conveyed through the use of visual depictions or the like.

Turning now to the methods associated with the present invention, one or more embodiments of the present invention provide methods and apparatus for trimming and/or cutting down the size of a stock window covering to custom fit a customer's window or other architectural opening dimensions. According to certain embodiments, a cut down apparatus and methods are provided which are relatively easy to practice and thereby reduce mistakes made in the process of cutting. Thus, in certain embodiments, a semi-automated machine is provided that is capable of simultaneously cutting both ends of the window covering. According to these embodiments, cutting of both sides of the blind at the same time increases the speed of the cutting cycle. In addition, such machine is provided with a calculation apparatus for easily entering desired window covering size values, and thereafter calculating and setting machine variables. In the following description, the above described cutting apparatus 30 and calculation apparatus (in the form of user interface 48) will be referred to throughout. However, it is noted that such methods may be utilized with different cutting machines and/or calculation apparatus, including but not limited to, machines and calculators having variations as discussed herein.

In one preferred method, a store employee or a customer can trim or cut down a window covering as follows. Initially, the customer and/or employee properly measures and records the dimensions of the window or architectural opening which is desired to be covered. The dimensions of the window or door opening are then entered into apparatus 30 via user interface 48. As discussed above, the entering of such information may include proceeding through various steps displayed on a screen or the like, as well as answering various questions. Upon completion of the entering steps and calculation steps performed by the calculator, stop element 52 and end plate 53 preferably automatically move into place with respect to stationary cutting device, in a position to permit the cutting mechanisms to be spaced in a manner so as to provide the desired dimensions for the finished window-covering product. As is also mentioned above, a customer and/or employee may be prompted during the calculation procedure to select a stock window covering 10 from the in store inventory.

Once the desired window covering 10 is selected, door 120 of apparatus 30 is opened, and a first end of the window covering is loaded into stationary cutting assembly 42. End plate 53 preferably provides a stop point for the end of the blind inserted into stationary cutting assembly 42. Preferably, the first end of window covering 10 is inserted into die 66 of stationary cutting assembly 42, and pushed up against end plate 53. The other side of window covering 10 is thereafter positioned in line to the opening in die 66 of moveable cutting assembly 44, with a portion of the other side being rested on support element 58 of stop element 52. Once window covering 10 is placed in this position, clamps 100 may be engaged thereto. As noted above, preferably, at least one of clamping arms 102 or 104 of clamps 100 are pivotable to enable one of the arms to be pivoted out of the way during loading of the window covering. In addition, one of the clamping arms of clamps 100 preferably serve to separate head rail 12 from window covering material 15 during the cutting operation. In other words, clamp arms 102 and 104 clamp window covering material 15 to bottom rail 14 of window covering 10, and one of the clamp arms thereby separates headrail 12 from the uppermost portion of window covering material 15. The pivotable clamp arm also helps line up the headrail with the die opening.

Moveable cutting assembly 44 is then moved into contact with the second end of window covering 10 and against stop element 52. This may be done manually or through an automated configuration. Once stop element 52 is positioned, aforementioned locking clamp 57 may be engaged with aforementioned extension arm 54 to lock moveable cutting assembly 44 to stop element 52. Preferably, the second end of window covering 10 is inserted into die 66 of moveable cutting device 44, just as the first end was placed into die 66 of cutting assembly 42. Stop element 52, which was moved into place after the dimensions of the finished window-covering product were entered, accurately determines the position of moveable cutting assembly 44. One or more clamps associated with the cutting mechanisms may then be tightened to secure window covering material 15 (for example, blind slats) together for the cutting operation.

The operator then closes door 120 to cut down machine 30, and activates cutting devices 42 and 44 by starting the machine. Starting the machine can be activated by a start button or other appropriate mechanism, such as the correct input of a security code or the like. As window covering 10 is being cut, end plate 53 moves away from the cut window covering material 15 and bottom rail 14, allowing them to fall directly into a scrap bin. Similarly, the scrap or cutoff on the right side is not impeded and is also free to fall into bins. The entire cutting/trimming process preferably takes less than ten seconds. Door 120 of cut down apparatus 30 is then opened, moveable cutting assembly 44 is released from the stop mechanism (which may require the operation of arm 54 and clamp 57), moveable cutting assembly 44 is moved away from the cut product, and window covering 10 is removed. The optional vacuum and blower system mentioned above may be operated so as to remove any dust particles from the finished product. Finally, waste material is preferably disposed of in the collection bins, which may be emptied at a later time.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An Apparatus for cutting a window covering having first and second ends, a headrail, a bottom rail and window covering material extending therebetween, said apparatus comprising:
a user interface for receiving information relating to said window covering;
a base;
a stationary cutting assembly and a moveable cutting assembly supported on said base, each cutting assembly including a die and a shear adapted to cut said headrail and a saw adapted to cut said window covering material and said bottom rail; and
a stop that is automatically positioned with respect to said stationary cutting assembly in response to said information received by said user interface, said stop allowing for said moveable cutting assembly to be properly positioned.

2. The apparatus according to claim 1, further comprising a motor operatively coupled to each drive mechanism for activating said cutting assemblies.

3. The apparatus according to claim 2, wherein said drive mechanism includes a carriage having a lead screw with rotating threads for driving said saw and a worm gear that drives an eccentric cam coupled to said shear.

4. The apparatus according to claim 1, further comprising an auxiliary cutting assembly located opposite said stationary cutting assembly.

5. The apparatus according to claim 1, wherein said user interface includes a calculation apparatus for determining the position of said stop.

6. The apparatus according to claim 1, further comprising a dust containment system.

7. The apparatus according to claim 6, wherein said dust containment system includes a vacuum and collection bins located beneath each of said cutting assemblies.

8. The apparatus according to claim 1, further comprising a door for covering said cutting assemblies during a cutting operation.

9. The apparatus according to claim 1, wherein said saws, dies and shears are replaceable.

10. The apparatus according to claim 1, wherein said die is a dual die mechanism.

11. A method of simultaneously cutting first and second ends of a window covering in a cutting machine comprising:
entering information relating to said window covering into a user interface of said cutting machine;
selecting an appropriately sized window covering;
inserting a first end of said window covering into a die of a stationary cutting assembly of said cutting machine;
inserting a second end of said window covering into a die of a moveable cutting assembly of said cutting machine;
activating said cutting assemblies so as to simultaneously cut the first and second ends of said window covering.

12. The method according to claim 11, wherein said entering step includes entering information selected from the group -consisting of window size, window covering type, mounting type, the number of window coverings to be cut, and the unit type to be utilized.

13. The method according to claim 11, wherein said selecting step is performed in response to information provided by said user interface.

14. The method according to claim 11, wherein said entering step includes positioning a stop in response to said information entered.

15. The method according to claim 14, further comprising the step of moving said moveable cutting assembly in relation to said stop.

16. The method according to claim 11, wherein said inserting steps include engaging a clamp with said window covering.

17. The method according to claim 11, further comprising the step of removing said window covering from said cutting machine and placing end caps on said first and second ends of said window covering.

18. A method for calculating cutting dimensions for trimming a window covering comprising:
providing the type of said window covering;
providing measurements of said window covering;
providing mounting information of said window covering;
verifying previously entered information;
referring to a data matrix of acceptable and available window covering sizes based on the previously entered information;
prompting a user to select a starting window covering size from a selected group, the selected group being a subset of said data matrix; and
calculating a stop value based upon the selected window covering size.

19. The method according to claim 18, further comprising the step of displaying said stop value as a graphic illustration.

20. The method according to claim 18, further comprising the step of transmitting said stop value to a cutting machine.
